(19) United States
(12) Patent Application Publication
(10) Pub. No.: US 2016/0065982 A1
(43) Pub. Date: Mar. 3, 2016

(54) METHOD FOR DETERMINING WHETHER OR NOT PRESENT IMAGE IS REFERENCE IMAGE, AND APPARATUS THEREFOR

(71) Applicant: SAMSUNG ELECTRONICS CO., LTD., Suwon-si Gyeonggi-do (KR)

(72) Inventors: Yong-jin CHO, Seoul (KR); Byeong-doo CHOI, Suwon-si (KR); Chan-yul KIM, Bucheon-si (KR); Min-woo PARK, Hwaseong-si (KR); Ho-cheon WEY, Seongnam-si (KR); Jae-won YOON, Seoul (KR); Jin-young LEE, Hwaseong-si (KR)

(73) Assignee: SAMSUNG ELECTRONICS CO., LTD., Suwon-si (KR)

(21) Appl. No.: 14/782,358

(22) PCT Filed: Apr. 7, 2014
(86) PCT No.: PCT/KR2014/003009

§ 371 Date: Oct. 5, 2015

Related U.S. Application Data
(60) Provisional application No. 61/808,759, filed on Apr. 5, 2013.
(60) Provisional application No. 61/810,006, filed on Apr. 9, 2013.

(51) Int. Cl. H04N 19/50; H04N 19/187; H04N 19/96; H04N 19/30; H04N 19/70; H04N 19/174; H04N 19/196

(52) U.S. Cl. CPC H04N 19/50; H04N 19/174; H04N 19/187; H04N 19/196; H04N 19/30; H04N 19/70; H04N 19/96

(57) ABSTRACT

Provided is a method of decoding a video, the method including: obtaining, from a received data stream, information indicating whether a current slice segment is a dependent slice segment; obtaining constraint information from a reserved bit included in the received data stream when the current slice segment is not the dependent slice segment, based on the obtained information; and determining whether the current image is used as a reference image for predicting another image, based on the obtained constraint information.

### TECHNICAL FIELD

The present disclosure relates to video encoding and decoding using inter prediction and interlayer prediction.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macro block having a predetermined size.

According to a video codec, an amount of data is reduced by a prediction method based on a characteristic that images of a video are highly correlated with each other temporally or spatially. According to the prediction method, image information is recorded by using a temporal or spatial distance between images, prediction errors, etc. so as to predict a current image by using neighboring images.

### DETAILED DESCRIPTION OF THE INVENTION

### Technical Problem

One or more exemplary embodiments include a method of determining whether a current image is referenced for inter prediction or interlayer prediction, and a prediction method according to the method.

### Technical Solution

According to one or more exemplary embodiments, there is provided a method of determining whether a current image is being referenced.

According to one or more exemplary embodiments, there is provided a method of decoding a video, the method including: obtaining, from a received data stream, information indicating whether a current slice segment is a dependent slice segment; obtaining constraint information from a reserved bit included in the received data stream when the current slice segment is not the dependent slice segment, based on the obtained information; and determining whether the current image is used as a reference image for predicting another image, based on the obtained constraint information

### Advantageous Effects of the Invention

One or more exemplary embodiments provide a method of efficiently performing interlayer prediction or inter prediction.

### DESCRIPTION OF THE DRAWINGS

FIG. 1 illustrates a block diagram of a structure of a video decoding device according to one or more exemplary embodiments.

FIG. 2 illustrates a flowchart of a method of determining whether a current image is used as a reference image for predicting another image based on a data stream received by a video decoding device, according to one or more exemplary embodiments.

FIG. 3 illustrates a flowchart of a method of deleting, by a video decoding device, data regarding a current image from a buffer after the current image is displayed when the current image is not used as a reference image for predicting another image, according to one or more exemplary embodiments.

FIG. 4 illustrates a block diagram of a structure of a video encoding device according to one or more exemplary embodiments.

FIG. 5 illustrates a flowchart of a method of generating, by a video encoding device, a data stream according to one or more exemplary embodiments.

FIG. 6 illustrates a syntax of a portion of a slice segment header according to one or more exemplary embodiments.

FIG. 7 illustrates a syntax of a portion of a slice segment header according to one or more exemplary embodiments.

FIG. 8 illustrates a block diagram of a video encoding device based on a coding unit according to a tree structure, according to an exemplary embodiment.

FIG. 9 illustrates a block diagram of a video decoding device based on a coding unit according to a tree structure, according to an exemplary embodiment.

FIG. 10 illustrates a concept of a coding unit according to an exemplary embodiment.

FIG. 11 illustrates a block diagram of an image encoder based on a coding unit, according to an exemplary embodiment.

FIG. 12 illustrates a block diagram of an image decoder based on a coding unit, according to an exemplary embodiment.

FIG. 13 illustrates coding units according to depths and partitions according to an exemplary embodiment.

FIG. 14 illustrates a relationship between a coding unit and a transformation unit according to an exemplary embodiment.

FIG. 15 illustrates encoding information according to depths according to an exemplary embodiment.

FIG. 16 illustrates deeper coding units according to depths according to an exemplary embodiment.

FIGS. 17 to 19 illustrate relationships a coding unit, a prediction unit, and a transformation unit according to one or more exemplary embodiments.

FIG. 20 illustrates a relationship between a coding unit, a prediction unit, and a transformation unit according to encoding mode information of Table 1.

FIG. 21 illustrates a physical structure of a disc in which a program is stored, according to an exemplary embodiment.

FIG. 22 illustrates a disc drive for recoding and reading a program by using a disc.

FIG. 23 illustrates an overall structure of a content supply system for providing a content distribution service.

FIGS. 24 and 25 illustrate an external structure and an internal structure of a mobile phone to which a video encoding method and a video decoding method are applied, according to one or more exemplary embodiments.

FIG. 26 illustrates a digital broadcasting system to which a communication system is applied.

FIG. 27 illustrates a network structure of a cloud computing system using a video encoding device and a video decoding device, according to an exemplary embodiment.

### BEST MODE

Disclosed is a method of decoding a video, the method including: obtaining, from a received data stream, information indicating whether a current slice segment is a dependent slice segment; obtaining constraint information from a reserved bit included in the received data stream when the current slice segment is not the dependent slice segment, based on the obtained information; and determining whether the current image is used as a reference image for predicting another image, based on the obtained constraint information.

### MODE OF THE INVENTION

Hereinafter, in one or more exemplary embodiments, the term ‘image’ may include a still image as well as a moving image such as a video.

Hereinafter, the term ‘sample’ may denote data that is assigned to a sampling location of an image and is to be processed. For example, pixels of an image in a spatial area may be samples.

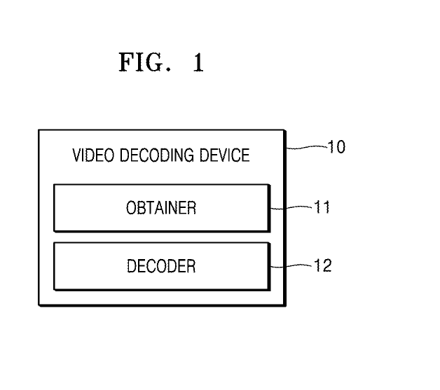

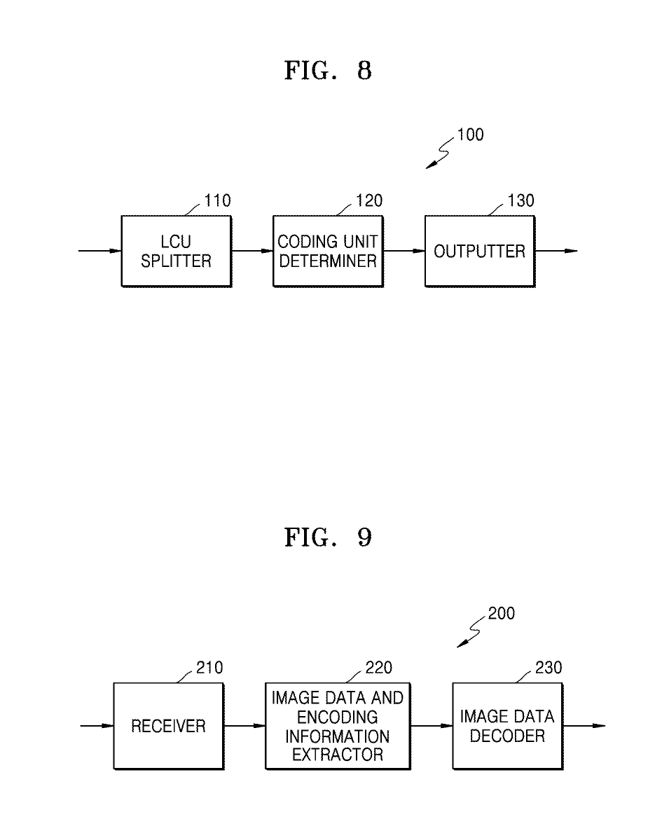

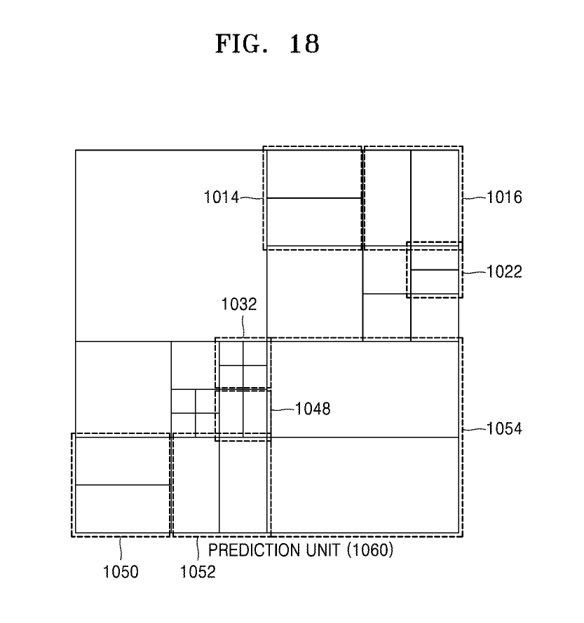

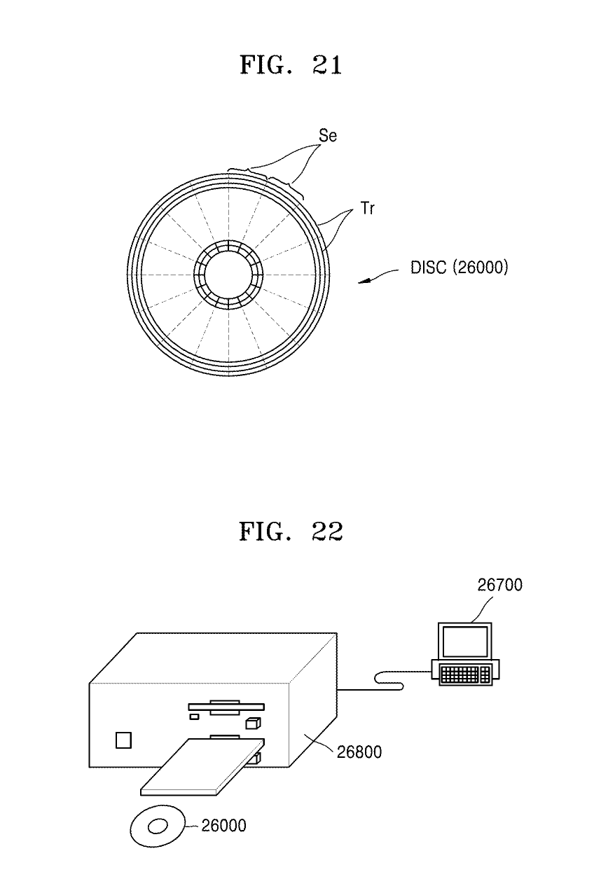

Hereinafter, referring to FIGS. 1 to 7, a method of and device for determining whether a current image is used as a reference image for predicting another image when video encoding and decoding involving prediction are performed will be described. Also, referring to FIGS. 8 to 20, method of encoding and decoding a video based on coding units having a tree structure will be described, and the coding units may be applicable to the aforementioned video encoding and decoding. Furthermore, referring to FIGS. 21 to 27, one or more exemplary embodiments that may be applied to the methods of encoding and decoding a video will be described.

FIG. 1 illustrates a block diagram of a structure of a video decoding device 10 according to one or more exemplary embodiments.

As illustrated in FIG. 1, the video decoding device 10 may include an obtainer 11 and a decoder 12. However, the video decoding device 10 may be embodied by using more or less components than the components illustrated in FIG. 1.

Hereinafter, the components will be sequentially described.

The video decoding device 10 may receive a data stream from the outside. The data stream may be a type of data formed of bits. The video decoding device 10 receives the data stream from the outside of the video decoding device 10 and may decode the received data stream.

The obtainer 11 may obtain, from the received data stream, information indicating whether a current slice segment is a dependent slice segment and may obtain constraint information from a reserved bit included in the received data stream when the current slice segment is not the dependent slice segment based on the obtained information.

A detailed operation of the obtainer 11 will be described later.

The decoder 12 may determine whether a current image is used as a reference image for predicting another image based on the constraint information obtained by the obtainer 11.

A detailed operation of the decoder 12 will be described later.

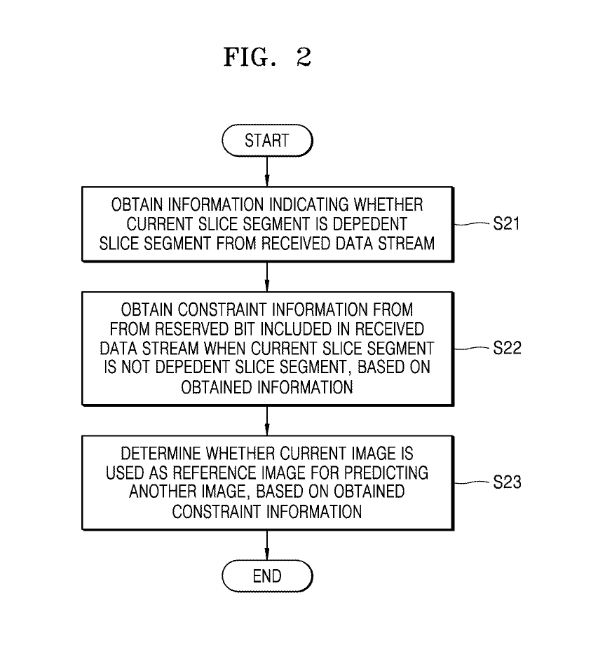

FIG. 2 illustrates a flowchart of a method of determining whether a current image is used as a reference image for predicting another image based on a data stream received by a video decoding device, according to one or more exemplary embodiments.

In operation S21, the video decoding device 10 obtains information indicating whether the current slice segment is the dependent slice segment from the received data stream.

The video decoding device 10 may receive the data stream. The data stream received by the video decoding device 10 may include Network Abstraction Layer (NAL) units.

The NAL unit may be a network abstraction layer unit that is a basic unit forming a bit stream. Also, one or more NAL units may be included in a data stream. The video decoding device 10 may receive the data stream including one or more NAL units from the outside.

The video decoding device 10 receives the data stream in order to split the received data stream into the NAL units and may decode each of the NAL units.

Each of the NAL units may include 2-byte header information. Also, the video decoding device 10 may roughly check information regarding data within each NAL unit by decoding the 2-byte header information included in each NAL unit.

An independent slice segment may include a slice segment header.

The dependent slice segment may be a slice segment for which the values of some syntax elements of the slice segment header are inferred from the values for the preceding independent slice segment in decending order.

As described above, the video decoding device 10 may receive the data stream. The video decoding device 10 may determine whether the current slice segment is the dependent slice segment or an independent slice segment. The video decoding device 10 may obtain information used to distinguish whether the current slice segment is the dependent slice segment or the independent slice segment, from the received data stream.

The video decoding device 10 may obtain information indicating whether the current slice segment is the dependent slice segment, from the received data stream. Therefore, the video decoding device 10 may determine whether the current slice segment is the dependent slice segment by using the received data stream.

Information necessary to determine whether the current slice segment is the dependent slice segment may be included in a slice segment header. The information necessary to determine whether the current slice segment is the dependent slice segment will be described later.

In operation S22, the video decoding device 10 obtains constraint information from a reserved bit included in the received data stream when the current slice segment is not the dependent slice segment, based on the information obtained in operation S21.

The video decoding device 10 may determine whether the current slice segment is the dependent slice segment based on the information obtained in operation S21.

For example, the video decoding device 10 may determine whether the current slice segment is the dependent slice segment or the independent slice segment by using the information included in the slice segment header from among the received data stream.

The received data stream may include reserved bits. Some bits included in the received data stream may be assigned to the reserved bits for the arbitrary purposes. The reserved bits may denote storage spaces in which information used for the arbitrary purposes is stored. The reserved bits may include constraint information.

The constraint information may include information regarding whether a current image may be referenced to predict other images except for the current image.

The data stream received by the video decoding device 10 may include the constraint information regarding whether the current image is referenced. Alternatively, the video decoding device 10 may obtain the constraint information regarding whether the current image may be referenced to predict another image, from the received data stream.

The other image referencing the current image may be present in a layer that is the same as or different from a layer in which the current image is present.

The video decoding device 10 may determine whether the current slice segment is the dependent slice segment by using the information obtained through the received data stream.

When it is determined that the current slice segment is not the dependent slice segment, the video decoding device 10 may additionally obtain the constraint information indicating whether the current image is used as the reference image for the other image.

The constraint information may be stored in the reserved bit of the slice segment header.

When a current slice is an independent slice, the video decoding device 10 may obtain the constraint information indicating whether the current image is used as the reference image for predicting the other image, from the received data stream.

Also, the constraint information may be of a flag type.

For example, flag information may be 1-bit information that becomes 1 when no image references the current image and becomes 0 when an image references the current image.

Also, the constraint information may be included in at least one of the slice segment header, a video parameter set, a sequence parameter set, and a picture parameter set.

For example, the constraint information may be included in the slice segment header. Also, the constraint information may be 1-bit information included in the slice segment header.

A picture may be split into multiple slices. Also, each slice may be split into slice segments.

The independent slice segment may include the slice segment header.

The dependent slice segment may be a slice segment for which the values of some syntax elements of the slice segment header are inferred from the values for the preceding independent slice segment in decending order.

The slice segment header may be included in a slice segment layer. The slice segment layer may include the slice segment header, slice segment data, and Raw Byte Sequence Payload (RBSP) tailing bits.

The RBSP may mean that a syntax structure is arranged in a byte unit and is encapsulated in the NAL unit. For example, types of the RBSP may be a sequence parameter set RBSP, a picture parameter set RBSP, a slice segment layer RBSP, or the like.

Also, the slice segment header may include a value of a syntax element ‘dependent_slice_segment_flag’ that is a parameter indicating whether a slice segment is dependent. ‘dependent_slice_segment_flag’ may be a syntax element indicating whether a decoded slice segment is an independent slice segment or a dependent slice segment. In more detail, when a value of ‘dependent_slice_segment_flag’ is equal to 1, the decoded slice segment is the dependent slice segment, and when a value of ‘dependent_slice_segment_flag’ is equal to 0, the decoded slice segment is the independent slice segment.

Also, bit spaces showing properties of the slice segment may be assigned in the slice segment header.

Also, the slice segment header may include the above-described constraint information.

The slice segment header may include an ID of a picture parameter set (PPS) referenced by the slice segment, a type of a slice, information regarding a picture list referenced by a slice, a quantization parameter (QP) of a slice, a sample adaptive offset (SAO) in a slice unit, and information regarding control of a de-blocking filter.

The constraint information may be flag information indicating whether the current image is used as the reference image for predicting another image other than the current image. Alternatively, the constraint information may be 1-bit data.

For example, when the constraint information is data of a flag type, the constraint information may be 1-bit information that becomes 1 when the current image is not used as a reference image for inter prediction and becomes 0 when the current image is used as the reference image for the inter prediction.

As another example, when the constraint information is the data of the flag type, the constraint information may be 1-bit information that becomes 1 when the current image is not used as a reference image for interlayer prediction and becomes 0 when the current image is used as the reference image for the interlayer prediction.

As another example, when the constraint information is the data of the flag type, the constraint information may be 1-bit information that becomes 1 when the current image is not used as a reference image for both the inter prediction and the interlayer prediction and becomes 0 when the current image is used as the reference image for both the inter prediction and the interlayer prediction.

In operation S23, the video decoding device 10 determines whether the current image is used as the reference image for predicting the other image, based on the constraint information obtained in operation S22.

The video decoding device 10 may determine that the current image is used as the reference image for predicting the other image or may determine that the current image is not used as the reference image for predicting the other image, based on the constraint information obtained in operation S22. Also, the video decoding device 10 may determine whether the current image is referenced to predicting other images other than the current image when the interlayer prediction between images included in different layers is performed.

When the video decoding device 10 determines that the current image is referenced to predict images in another layer, the video decoding device 10 may store data regarding the current image in a buffer until the current image is referenced for images in another layer.

The other layer may indicate a layer regarding other images having a view different from that of a current layer.

For example, when a current view image is decoded, the video decoding device 10 may check whether a current image included in a current view image sequence is referenced when another view image is decoded. If the video decoding device 10 checks that the current image is referenced when another view image is decoded, the video decoding device 10 may store data regarding the current in the buffer until the current image is referenced for other view images.

Alternatively, if the video decoding device 10 checks that the current image is not referenced when another view image is decoded, the video decoding device 10 may delete the data regarding the current image from the buffer after the current image is displayed.

Also, when inter prediction between images in the same layer is performed, the video decoding device 10 may determine whether the current image is referenced for other images other than the current image. When the inter prediction between the images in the same layer is performed, the video decoding device 10 may determine whether the current image is referenced for an image having a picture order count (POC) that is different from that of the current image.

When the video decoding device 10 determines that the current image is referenced to predict other images in the same layer, the video decoding device 10 may store the data regarding the current image in the buffer until the current image is referenced for the other images in the same layer.

Being referenced for other images in the same layer means that the current image is used to predict other images while inter prediction for other images included in a layer different from a current layer including the current image is performed.

For example, when an image of which a POC is 8 is decoded, the video decoding device 10 may check whether the current image is referenced when a previously decoded image of which a POC is not 8 is decoded, by using the constraint information.

When the video decoding device 10 checks that the current image is referenced when the previous decoded image of which the POC is not 8 is decoded, the video decoding device 10 may store data regarding the current image in the buffer until the current image is referenced for other view images that are previously decoded and have the POC that is not 8.

Alternatively, when the video decoding device 10 checks that the current image is not referenced for the previously decoded image of which the POC is not 8 is decoded, the video decoding device 10 may delete the data regarding the current image from the buffer after the current image is displayed.

The video decoding device 10 may obtain data regarding the slice segment header from the received data stream. The video decoding device 10 may also obtain flag information indicating whether the current image is used as the reference image for predicting other images other than the current image, from the received slice segment header. Also, a flag indicating whether the current image is used as a reference image for predicting other images other than the current image may be ‘discardable_flag’.

For example, ‘discardable_flag’ may be 1-bit information that becomes 1 when the current image is not used as a reference image for inter prediction and becomes 0 when the current image is used as the reference image for the inter prediction.

As another example, ‘discardable_flag’ may be 1-bit information that becomes 1 when the current image is not used as a reference image for interlayer prediction and becomes 0 when the current image is used as the reference image for the interlayer prediction.

As another example, ‘discardable_flag’ may be 1-bit information that becomes 1 when the current image is not used as a reference image for both the inter prediction and the interlayer prediction and becomes 0 when the current image is used as the reference image for both the inter prediction and the interlayer prediction.

A unit of the current image may include at least one of a picture sequence, a picture, a slice, a slice segment, a coding tree unit, a coding unit, a prediction unit, and a transformation unit.

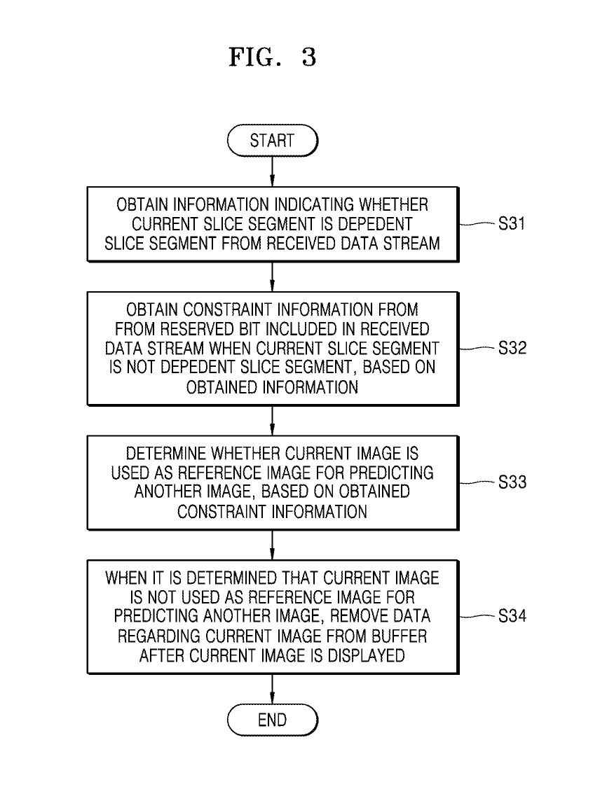

FIG. 3 illustrates a flowchart of a method of deleting, by the video decoding device 10, data regarding a current image from a buffer after the current image is displayed when the current image is not used as a reference image for another image, according to one or more exemplary embodiments.

Operations S31 to S33 respectively correspond to operations S21 to S23, and thus, detailed descriptions thereof will be omitted for convenience.

When it is determined that the current image is not used as the reference image for predicting another image in operation S33, the video decoding device 10 deletes data regarding the current image from the buffer after the current image is displayed in operation S34.

The video decoding device 10 may store some decoded pictures having a high correlation with a picture to be coded and may user the stored decoded pictures for inter prediction or interlayer prediction. The video decoding device 10 may store the decoded pictures in the buffer in order to use the same for the inter prediction or interlayer prediction. Also, a storage space in which the video decoding device 10 stores the decoded pictures for inter prediction or interlayer prediction may be a decoded picture buffer (DPB).

When it is determined that the current image is not used as the reference image for predicting the other image in operation S33, the video decoding device 10 may delete the data regarding the current image from the buffer after the current image is displayed. Also, when it is determined that the current image is not used as the reference image for predicting the other image in operation S33, the video decoding device 10 may store the data regarding the current image from the buffer after the current image is displayed.

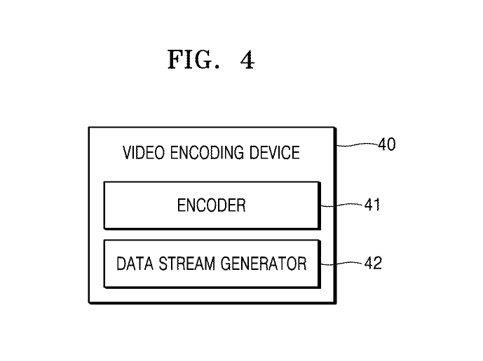

FIG. 4 illustrates a block diagram of a structure of a video encoding device 40 according to one or more exemplary embodiments.

As illustrated in FIG. 4, the video encoding device 40 may include an encoder 41 and a data stream generator 42.

However, the video encoding device 40 may be embodied by more or less components than the components illustrated in FIG. 4.

Hereinafter, the components will be sequentially described.

The encoder 41 determines whether a current slice segment is a dependent slice segment and determines whether a current image is used as a reference image for predicting another image when the current slice segment is not the dependent slice segment. The encoder 41 may determine constraint information regarding whether the current image is used as the reference image for predicting the other image, and the determined constraint information may be assigned to reserved bits.

A detailed operation of the encoder 41 will be described later.

The data stream generator 42 may generate a data stream including the reserved bits determined by the encoder 41.

A detailed operation of the data stream generator 42 will be described later.

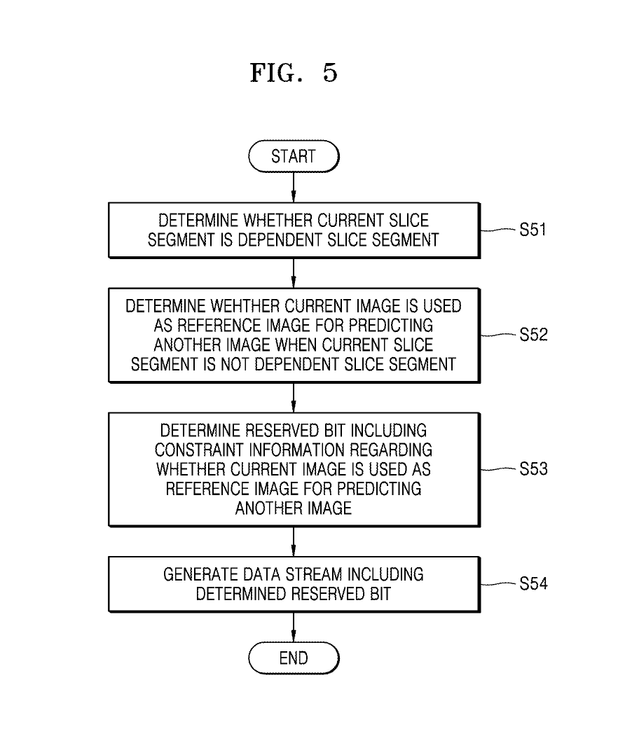

FIG. 5 illustrates a flowchart of a method of generating, by the video encoding device 40, a data stream according to one or more exemplary embodiments.

In operation S51, the video encoding device 40 determines whether a current slice segment is a dependent slice segment.

The video encoding device 40 may determine whether the current slice segment is the dependent slice segment or an independent slice segment. The video encoding device 40 may generate data including information used to distinguish whether the current slice segment is the dependent slice segment or the independent slice segment, according to the determination as to whether the current slice segment is the dependent slice segment.

The video encoding device 40 may include, in a slice segment header, the information used to distinguish whether the current slice segment is the dependent slice segment or the independent slice segment.

In operation S52, when the current slice segment is not the dependent slice segment, the video encoding device 40 determines whether a current image is used as a reference image for predicting another image.

The video encoding device 40 may determine that the current image is used as the reference image for predicting the other image or may determine that the current image is used as the reference image for predicting the other image. Also, the video encoding device 40 may determine whether the current image is referenced to predict images other than the current image, when interlayer prediction between images in different layers is performed. Also, the video encoding device 40 may determine whether the current image is referenced to predict the images other than the current image, when the inter prediction between the images in the same layer is performed.

The video encoding device 40 may determine whether the current image is used as the reference image for predicting other images when the current slice segment is not the dependent slice segment.

The video encoding device 40 may determine whether the current image is used as the reference image for predicting the other images when the current slice segment is not the dependent slice segment in operation S51.

For example, when it is determined that current slice segment is not the dependent slice segment in operation S51, the video encoding device 40 may determine whether the current image is referenced to predict other images other than the current image, when interlayer prediction between images in the different layers is performed. As another example, when it is determined that current slice segment is not the dependent slice segment in operation S51, the video encoding device 40 may determine whether the current image is referenced to predict the images other than the current image, when inter prediction between images in the same layer is performed.

When the video encoding device 40 determines that the current image is referenced to predict images in other layers, the video encoding device 40 may generate control information used to store data regarding the current image in the buffer until the current image is referenced for images is other layers.

For example, when a current view image is encoded, the video encoding device 40 may determine whether a current image included in a current view image sequence is referenced when another view image is encoded. When it is determined that the current image is referenced when the other view image is encoded, the video encoding device 40 may generate the control information used to store the data regarding the current image in the buffer until the current image is referenced for images is other layers.

Alternatively, when the video encoding device 40 determines that the current image is not referenced when the other view image is encoded, the video encoding device 40 may generate control information used to delete the data regarding the current image from the buffer after the current image is displayed.

Also, the video encoding device 40 may determine whether the current image is referenced for images other than the current image when inter prediction between images included in the same layer is performed. The video encoding device 40 may determine whether the current image is referenced for an image having a POC different from that of the current image when the inter prediction between the images included in the same layer is performed.

When the video encoding device 40 determines that the current image is referenced to predict the images included in the same layer, the video encoding device 40 may generate the control information used to store the data regarding the current image in the buffer until the current image is referenced for another image included in the same layer.

Being referenced for other images included in the same layer may mean that the current image may be used to predict other images while inter prediction for other images included in a layer different from a layer including the current image is performed.

The video encoding device 40 may include, in the slice segment header, flag information indicating whether the current image is used as a reference image for predicting the images other than the current image. Also, a flag indicating whether the current image is used as the reference image for predicting the images other than the current image may be ‘discardable_flag’.

For example, ‘discardable_flag’ may be 1-bit information that becomes 1 when the current image is not used as a reference image for the inter prediction and becomes 0 when the current image is used as the reference image for the inter prediction.

As another example, ‘discardable_flag’ may be 1-bit information that becomes 1 when the current image is not used as a reference image for the interlayer prediction and becomes 0 when the current image is used as the reference image for the interlayer prediction.

As another example, ‘discardable_flag’ may be 1-bit information that becomes 1 when the current image is not used as a reference image for the inter prediction and the interlayer prediction and becomes 0 when the current image is used as the reference image for the inter prediction and the interlayer prediction.

In operation S53, the video encoding device 40 determines reserved bits including the constraint information regarding whether the current image is used as the reference image for predicting other images.

A unit of the current image may include at least one of a picture sequence, a picture, a slice, a slice segment, a coding tree unit, a coding unit, a prediction unit, and a transformation unit.

The constraint information may include information regarding whether the current image is used as the reference image for predicting images other than the current image.

Other images referencing the current image may be present in a layer that is the same as or different from the layer including the current image.

When it is determined that the current slice segment is not the dependent slice segment, the video encoding device 40 may additionally determine the constraint information indicating whether the current image is used as the reference image for other images.

When a current slice is an independent slice, the video encoding device 40 may determine the constraint information indicating whether the current image is used as the reference image for other images.

Also, the constraint information may be of a flag type.

For example, flag information may be 1-bit information that becomes 1 when no image references the current image and becomes 0 when an image references the current image.

Also, the constraint information may be included in at least one of a slice segment header, a video parameter set, a sequence parameter set, and a picture parameter set.

For example, the constraint information may be included in the slice segment header. Also, the constraint information may be 1-bit information included in the slice segment header.

The picture may be split into multiple slices. Also, each slice may be split into slice segments.

An independent slice segment may include the slice segment header.

The dependent slice segment may be a slice segment for which the values of some syntax elements of the slice segment header are inferred from the values for the preceding independent slice segment in decending order.

The slice segment header may be included in the slice segment layer. The slice segment layer may include the slice segment header, the slice segment data, RBSP, tailing bits.

The RBSP may mean that a syntax structure is arranged in a byte unit and is encapsulated in the NAL unit. For example, types of the RBSP may be a sequence parameter set RBSP, a picture parameter set RBSP, a slice segment layer RBSP, or the like.

Also, the slice segment header may include a value of a syntax element ‘dependent_slice_segment_flag’ that is a parameter indicating whether a slice segment is dependent. ‘dependent_slice_segment_flag’ may be a syntax element indicating whether a decoded slice segment is an independent slice segment or a dependent slice segment. In more detail, when a value of ‘dependent_slice_segment_flag’ is equal to 1, the decoded slice segment is the dependent slice segment, and when a value of ‘dependent_slice_segment_flag’ is equal to 0, the decoded slice segment is the independent slice segment.

Also, bit spaces showing properties of the slice segment may be assigned in the slice segment header.

Also, the video encoding device 40 may include the constraint information in the slice segment header.

The slice segment header may include an ID of a PPS referenced by the slice segment, a type of a slice, information regarding a picture list referenced by a slice, a QP of a slice, a SAO in a slice unit, and information regarding control of a de-blocking filter.

The constraint information may be flag information indicating whether the current image is used as the reference image for predicting another image other than the current image. Alternatively, the constraint information may be 1-bit data.

For example, when the constraint information is data of a flag type, the constraint information may be 1 when the current image is not used as a reference image for inter prediction and may be 0 when the current image is used as the reference image for the inter prediction.

As another example, when the constraint information is the data of the flag type, the constraint information may be bit information that becomes 1 when the current image is not used as a reference image for interlayer prediction and becomes 0 when the current image is used as the reference image for the interlayer prediction.

As another example, when the constraint information is the data of the flag type, the constraint information may be bit information that becomes 1 when the current image is not used as a reference image for both the inter prediction and the interlayer prediction and becomes 0 when the current image is used as the reference image for both the inter prediction and the interlayer prediction.

In operation S54, the video encoding device 40 generates a data stream including the reserved bits that are determined in operation S53.

As described above, the constraint information may be included in the reserved bits that are determined in operation S53.

The video encoding device 40 may generate a data stream. The data stream generated by the video encoding device 40 may include NAL units.

The NAL unit may be a network abstraction layer unit that is a basic unit forming a bit stream. Also, one or more NAL units may be included in a data stream. The video encoding device 40 may generate the data stream including one or more NAL units.

The video encoding device 40 may generate a data stream by encoding each NAL unit and combining the NAL units.

Each of the NAL units may include 2-byte header information. Also, the video encoding device 40 may encode the NAL units such that brief information regarding data within each NAL unit may be included in the 2-byte header information.

The video encoding device 40 may determine whether the current slice segment is the dependent slice segment. The video encoding device 40 may generate a data stream including information indicating whether the current slice segment is the dependent slice segment.

The video encoding device 40 may include, in the slice segment header, information necessary to determine whether the current slice segment is the dependent slice segment.

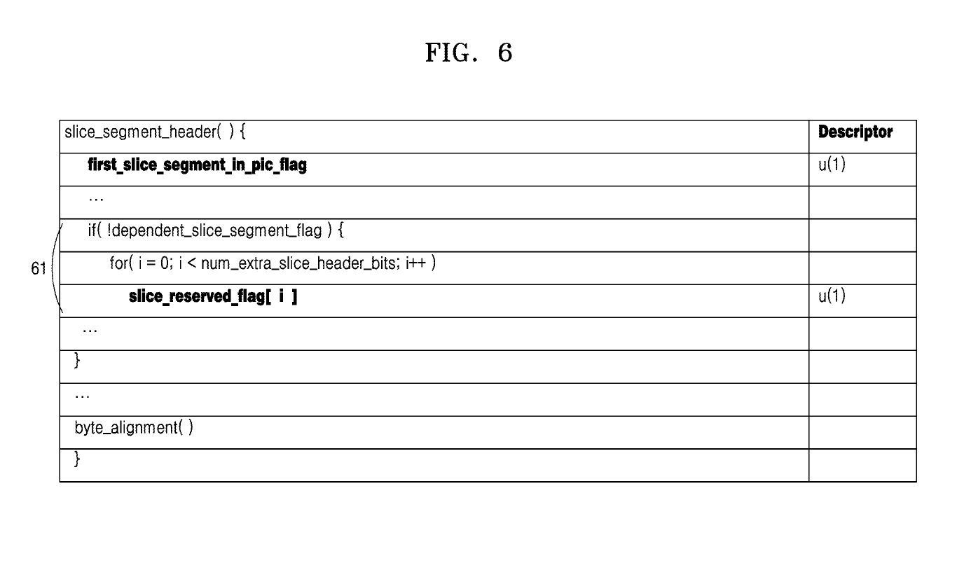

FIG. 6 illustrates a syntax of a portion of a slice segment header according to one or more exemplary embodiments.

The video decoding device 10 according to one or more exemplary embodiments may parse the syntax of FIG. 6 from among received data streams. The video decoding device 10 may obtain a slice segment header from the received data streams. The video decoding device 10 may read reserved bits by analyzing the syntax of FIG. 6.

In a slice segment header syntax, a syntax element “first_slice_segment_in_pic_flag” may be placed first. When a value of “first_slice_segment_in_pic_flag” is equal to 1, it may be found that a current slice segment is a first slice segment in a decoded picture. That is, the syntax element “first_slice_segment_in_pic_flag” may be a flag indicating whether the current slice segment is the first slice segment.

Also, the slice segment header syntax may include a syntax element “dependent_slice_segment_flag”. When a value of the syntax element “dependent_slice_segment_flag” is equal to 1, it may be found that a decoded slice segment is a dependent slice segment.

When the value of the syntax element “dependent_slice_segment_flag” is not equal to 1, the video decoding device 10 may determine that the decoded slice segment is not the dependent slice segment. Alternatively, when the value of the syntax element “dependent_slice_segment_flag” is equal to 0 or is not present, the video decoding device 10 may determine that the decoded slice segment is an independent slice segment.

Also, according to whether the current slice segment is the dependent slice segment, a determination as to whether the “slice_reserved_flag” is to be read may be made.

When “dependent_slice_segment_flag” is not equal to 1 in a conditional statement 61, the video decoding device 10 may read a slice_reserved_flag[i] of which the number is the same as that of num_extra_slice_header_bits. Alternatively, when dependent_slice_segment_flag is not equal to 1 in the conditional statement 61, the video decoding device 10 may read slice_reserved_flag[i] of which the number is the same as that of bits in an additional slice header.

num_extra_slice_header_bits may indicate the number of bits in an additional slice header.

Max_sublayer_for_ilp_plus1[j] is a parameter indicating the maximum number of sub-layers capable of being interlayer-predicted.

TemporalId may indicate an order of a current sub-layer.

A non-random access point (RAP) picture may indicate a type of a picture other than an arbitrarily accessible picture.

slice_reserved_flag[0] may indicate whether an encoded slice is referenced for interlayer prediction, when “Max_sublayer_for_ilp_plus1[j]−1” is equal to or greater than TemporalID regarding j^{th} layer including the encoded slice. Alternatively, slice_reserved_flag[0] may indicate whether an encoded slice is referenced for interlayer prediction, only when a layer has a number that is smaller than or equal to the maximum number of sub-layers during the interlayer prediction.

When slice_reserved_flag[0] is equal to 1, the encoded slice may not be referenced for the interlayer prediction.

With regard to a sub-layer of the j^{th} layer of which TemporalId is greater than “max_sublayer_for_ilp_plus1[j]−1”, slice_reserved_flag[0] may be equal to 1. Alternatively, the video decoding device 10 may determine that a slice included in a sub-layer is not referenced for the interlayer prediction, wherein the sub-layer has a number that is greater than the maximum number of sub-layers.

When “max_sublayer_for_ilp_plus1[j]−1” is 0, slice_reserved_flag[0] of the non-RAP picture may be 1. Alternatively, the video decoding device 10 may determine that the non-RAP picture is not referenced for the interlayer prediction from among slices included in a sub-layer having a number that is greater than the maximum number of sub-layers.

When a value of “max_sublayer_for_ilp_plus1[j]−1” is null, a value of slice_reserved_flag[0] may be considered to be 1. Also, when i is greater than 0, slice_reserved_flag[i] may be used for additional purposes. The additional purposes may be determined later. When i is greater than 0, slice_reserved_flag[i] may be a type of a reserved bit.

A value of slice_reserved_flag[0] may indicate whether an encoded slice is referenced for interlayer prediction. For example, when the value of slice_reserved_flag[0] is 0, the encoded slice may be referenced for interlayer prediction or inter prediction. As another example, when the value of slice_reserved_flag[0] is 1, the encoded slice may not be referenced for interlayer prediction or inter prediction.

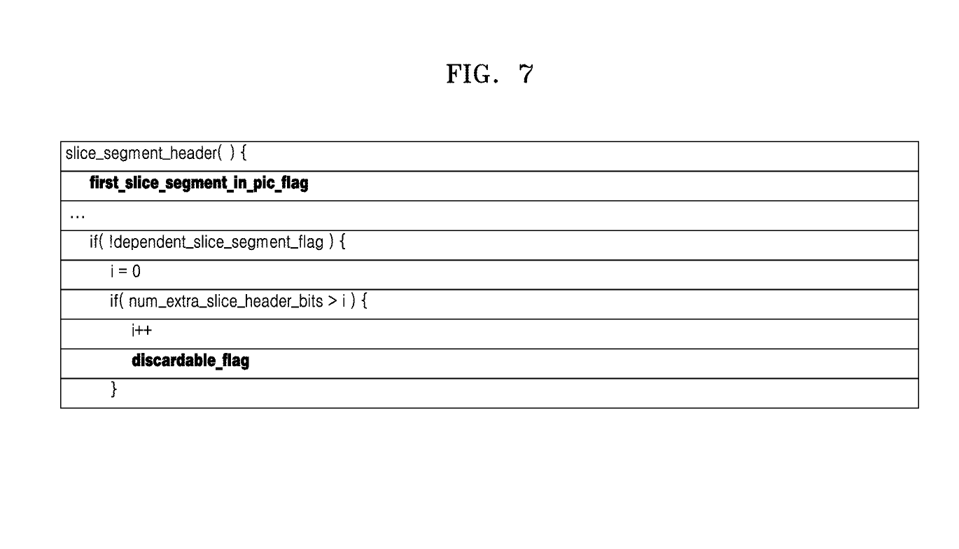

FIG. 7 illustrates a syntax of a portion of a slice segment header according to one or more exemplary embodiments.

In a slice segment header syntax, a syntax element “first_slice_segment_in_pic_flag” may be placed first. When a value of “first_slice_segment_in_pic_flag” is equal to 1, it may be found that a current slice segment is a first slice segment in a decoded picture. That is, the syntax element “first_slice_segment_in_pic_flag” may be a flag indicating whether the current slice segment is the first slice segment.

Also, the slice segment header syntax may include a “dependent_slice_segment_flag” syntax element. When a value of the “dependent_slice_segment_flag” syntax element of the slice segment header is 1, a decoded slice segment may be a dependent slice segment.

When the value of the “dependent_slice_segment_flag” syntax element of the slice segment header is not 1, the video decoding device 10 may determine that the decoded slice segment is not the dependent slice segment. Alternatively, when the value of the “dependent_slice_segment_flag” syntax element of the slice segment header is 0 or null, the video decoding device 10 may determine that the decoded slice segment is an independent slice segment.

In addition, according to whether a current slice segment is a dependent slice segment, a determination as to whether to read “discardable_flag” may be made.

In the conditional statement 61, the video decoding device 10 may read slice_reserved_flag[i] of which the number of the same as that of num_extra_slice_header_bits, when a value of dependent_slice_segment_flag is not 1. Alternatively, in the conditional statement 61, the video decoding device 10 may read slice_reserved_flag[i] of which the number of the same as that of bits in an additional slice header, when a value of dependent_slice_segment_flag is not 1.

Also, the video decoding device 10 may read “discardable_flag” when it is determined that a decoded slice segment is an independent slice segment.

Also, the video decoding device 10 may read “discardable_flag” when the number of bits in the additional slice header to be decoded is greater than 0. Alternatively, when the number of bits in the additional slice header is 0 while decoding is performed, the video decoding device 10 may not read “discardable_flag”.

“dependent_slice_segment_flag” having a value of 1 may indicate that an encoded picture may not be used as a reference picture for inter prediction and interlayer prediction while subsequent pictures are decoded. dependent_slice_segment_flag” having a value of 0 may indicate that an encoded picture may be used as a reference picture for inter prediction and interlayer prediction while subsequent pictures are decoded. Also, when “dependent_slice_segment_flag” does not have a value, a value of “dependent_slice_segment_flag” may be considered to be 0.

FIG. 8 illustrates a block diagram of the video encoding device 100 based on a coding unit according to a tree structure, according to an exemplary embodiment.

The video encoding device 100 involving video prediction based on coding units according to a tree structure includes a coding unit determiner 120 and an output unit 130. Hereinafter, for convenience, the video encoding device 100 involving the video prediction based on the coding units according to the tree structure will be concisely referred to as the ‘video encoding device 100’.

The coding unit determiner 120 may split a current picture based on a largest coding unit (LCU) that is a coding unit having a maximum size for a current picture of an image. If the current picture is larger than the LCU, image data of the current picture may be split into the at least one LCU. The LCU according to one or more exemplary embodiments may be a data unit having a size of 32×32, 64×64, 128×128, 256×256, etc., and a shape of the data unit may be a square having a width and length in squares of 2.

A coding unit according to one or more exemplary embodiments may be characterized by a maximum size and a depth. The depth denotes the number of times the coding unit is spatially split from the LCU, and as the depth deepens, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU deepens, a coding unit according to an upper depth may include a plurality of coding units according to lower depths.

As described above, the image data of the current picture is split into the LCUs according to a maximum size of the coding unit, and each of the LCUs may include deeper coding units that are split according to depths. Since the LCU according to one or more exemplary embodiments is split according to depths, image data of a space domain included in the LCU may be hierarchically classified according to depths.

A maximum depth and a maximum size of a coding unit, which limit the total number of times a height and a width of the LCU are hierarchically split, may be predetermined.

The coding unit determiner 120 encodes at least one split region obtained by splitting a region of the LCU according to depths, and determines a depth to output a finally encoded image data according to the at least one split region. In other words, the coding unit determiner 120 selects a depth having the least encoding error by encoding the image data in the deeper coding units according to depths, according to the LCU of the current picture, and determines the selected depth as a final depth. The determined final depth and the image data in each LCU are output to the output unit 130.

The image data in the LCU is encoded based on the deeper coding units according to the depths, according to at least one depth equal to or below the maximum depth, and results of encoding the image data are compared based on each of the deeper coding units according to the depths. A depth having the least encoding error may be selected after comparing encoding errors of the deeper coding units. At least one final depth may be selected for each LCU.

The size of the LCU is split as a coding unit is hierarchically split according to depths, and the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the depths may differ according to regions in the image data. Thus, one or more depths may be determined in one LCU, and the image data of the LCU may be divided according to coding units of at least one depth.

Accordingly, the coding unit determiner 120 may determine coding units having a tree structure included in a current LCU. The ‘coding units having a tree structure’ according to one or more exemplary embodiments include coding units corresponding to a depth determined to be the final depth, from among all deeper coding units according to depths included in the current LCU. A coding unit of a final depth may be hierarchically determined according to depths in the same region of the LCU, and may be independently determined in different regions. Similarly, a depth in a current region may be independently determined from a depth in another region.

A maximum depth according to one or more exemplary embodiments is an index related to the number of splitting times from a LCU to a SCU. A first maximum depth according to one or more exemplary embodiments may denote the total number of splitting times from the LCU to the SCU. A second maximum depth according to one or more exemplary embodiments may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth deepens. For convenience of description, the prediction encoding and the transformation will now be described based on a coding unit of a current depth, in a LCU.

The video encoding device 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding device 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, N×N, or the like. Examples of a partition mode may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, partitions having arbitrary shapes, and the like.

A prediction mode of the prediction unit may be at least one of an intra mode, a inter mode, and a skip mode. For example, the intra mode and the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding device 100 may also perform the transformation on the image data in a coding unit based not only on the coding unit for encoding the image data, but also based on a data unit that is different from the coding unit. In order to perform the transformation in the coding unit, the transformation may be performed based on a transformation unit having a size smaller than or equal to the coding unit. For example, the transformation unit may include a data unit for an intra mode and a transformation unit for an inter mode.

The transformation unit in the coding unit may be recursively split into smaller sized regions in the similar manner as the coding unit according to the tree structure. Thus, residues in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Splitting information according to depths requires not only a depth but also information regarding prediction and transformation. Accordingly, the coding unit determiner 120 not only determines a depth having a least encoding error, but also determines a partition mode in which a prediction unit is split into partitions, a prediction mode according to prediction units, and a size of a transformation unit for transformation.

Coding units according to a tree structure in a LCU and methods of determining a prediction unit/partition, and a transformation unit, according to one or more exemplary embodiments, will be described in detail below with reference to FIGS. 9 through 19.

The coding unit determiner 120 may measure an encoding error of deeper coding units according to depths by using Rate-Distortion Optimization based on Lagrangian multipliers.

The output unit 130 outputs the image data of the LCU, which is encoded based on the at least one depth determined by the coding unit determiner 120, and splitting information according to depths, in bit streams.

The encoded image data may be obtained by encoding residual data of an image.

The splitting information according to depths may include information regarding the depth, about the partition mode in the prediction unit, the prediction mode, and the size of the transformation unit.

The information regarding the final depth may be defined by using splitting information according to depths, which indicates whether encoding is performed on coding units of a lower depth instead of a current depth. If the current depth of the current coding unit is the depth, the current coding unit is encoded in a coding unit according to a current depth, and thus, splitting information of the current depth may be defined not to split the current coding unit to a lower depth. Alternatively, if the current depth of the current coding unit is not the depth, the encoding is performed on the coding unit of the lower depth, and thus the splitting information of the current depth may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and splitting information regarding at least one encoding unit is determined for a coding unit of a depth, the splitting information regarding at least one encoding unit may be determined for one LCU. Also, a depth of the data of the LCU may be different according to locations since the data is hierarchically split according to depths, and thus the splitting information and depth may be set for the data.

Accordingly, the output unit 130 may assign encoding information regarding the depth and the encoding mode to at least one of the coding unit, the prediction unit, and a minimum unit included in the LCU

The minimum unit according to one or more exemplary embodiments is a square data unit obtained by splitting the SCU constituting the lowermost depth by 4. Alternatively, the minimum unit according to an exemplary embodiment may be a maximum square data unit that may be included in all of the coding units, prediction units, partition units, and transformation units included in the LCU.

For example, the encoding information output by the output unit 130 may be classified into encoding information according to deeper coding units, and encoding information according to prediction units. The encoding information according to the deeper coding units may include the information regarding the prediction mode and about the size of the partitions. The encoding information transmitted according to the prediction units may include information regarding an estimated direction of an inter mode, about a reference image index of the inter mode, about a motion vector, about a chroma component of an intra mode, and about an interpolation method of the intra mode.

Information regarding a maximum size of the coding unit defined according to pictures, slices, or GOPs, and information regarding a maximum depth may be inserted into a header of a bit stream, a sequence parameter set, or a picture parameter set.

Information regarding a maximum size of the transformation unit permitted with respect to a current video, and information regarding a minimum size of the transformation unit may also be output through a header of a bit stream, a sequence parameter set, or a picture parameter set. The output unit 130 may encode and output reference information regarding prediction, prediction information, and slice type information.

In the video encoding device 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding device 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding device 100, image compression efficiency may be increased since a coding unit is adjusted while considering characteristics of an image while increasing a maximum size of a coding unit while considering a size of the image.

The video encoding device 40 described with reference to FIG. 4 may include video encoding devices 100 of which the number is the same as that of layers in order to encode single-layer images in layers of a multilayer video. For example, a first layer encoder 12 includes one video encoding device 100, and a second layer encoder 14 may include video encoding devices 100 of which the number is the same as that of second layers.

When the video encoding device 100 encodes images in a first layer, the coding unit determiner 120 may determine a prediction unit used to predict images for coding units according to the tree structure in a LCU and may perform prediction on the images in the prediction unit.

When the video encoding device 100 encodes images in a second layer, the coding unit determiner 120 may determine a coding unit according to the tree structure and a prediction unit in a LCU and may perform prediction in the prediction unit.

The video encoding device 100 may encode a brightness difference in order to compensate for a brightness difference between the images in the first layer and the images in the second layer. However, whether to compensate for the brightness differences may be determined according to an encoding mode of the coding unit. For example, brightness compensation may be performed only for a coding unit of 2N×2N.

FIG. 9 illustrates a block diagram of a video decoding device 200 based on a coding unit according to a tree structure, according to an exemplary embodiment.

The video decoding device 200 that involves video prediction based on coding units according to a tree structure includes a receiver 210, an image data and encoding information extractor 220, and an image data decoder 230. Hereinafter, for convenience, the video decoding device 200 involving the video prediction based on the coding units according to the tree structure will be referred to as the ‘video decoding device 200’.

Definitions of various terms, such as a coding unit, a depth, a prediction unit, a transformation unit, and splitting information, for decoding operations of the video decoding device 200 are identical to those described with reference to FIG. 8 and the video encoding device 100.

The receiver 210 receives and parses a bit stream of an encoded video. The image data and encoding information extractor 220 extracts encoded image data for each coding unit from the parsed bit stream, wherein the coding units have a tree structure according to each LCU, and outputs the extracted image data to the image data decoder 230. The image data and encoding information extractor 220 may extract information regarding a maximum size of a coding unit of a current picture, from a header about the current picture, a sequence parameter set, or a picture parameter set.

Also, the image data and encoding information extractor 220 extracts splitting information and a final depth for the coding units having a tree structure according to each LCU, from the parsed bit stream. The extracted splitting information and final depth are output to the image data decoder 230. In other words, the image data in a bit stream is split into the LCU so that the image data decoder 230 decodes the image data for each LCU.

The splitting information and depths according to the LCU may be set for at least one piece of depth information, and splitting information according to the depth may include information regarding a partition mode of a corresponding coding unit, information regarding a prediction mode, and splitting information of a transformation unit. Also, splitting information according to depths may be extracted as the depth information.

The splitting information and the depth according to each LCU extracted by the image data and encoding information extractor 220 is splitting information and a depth determined to generate a minimum encoding error when an encoder, such as the video encoding device 100, repeatedly performs encoding for each deeper coding unit according to depths according to each LCU. Accordingly, the video decoding device 200 may reconstruct an image by decoding the image data according to a depth and an encoding mode that generates the minimum encoding error.

Since encoding information regarding a depth and an encoding mode may be assigned to a predetermined data unit from among a corresponding coding unit, a prediction unit, and a minimum unit, the image data and encoding information extractor 220 may extract the splitting information and the depth according to the predetermined data units. If splitting information and depth of a corresponding LCU are recorded according to predetermined data units, the predetermined data units to which the same splitting information and the depth are assigned may be inferred to be the data units included in the same LCU.

The image data decoder 230 reconstructs the current picture by decoding the image data in each LCU based on the splitting information and the depth according to the LCUs. In other words, the image data decoder 230 may decode the encoded image data based on the partition mode, the prediction mode, and the transformation unit for each coding unit from among the coding units having the tree structure included in each LCU. A decoding process may include prediction including intra prediction and motion compensation, and an inverse transformation.

The image data decoder 230 may perform intra prediction or motion compensation according to a partition and a prediction mode of each coding unit, based on the information regarding the partition mode and the prediction mode of the prediction unit of the deeper coding unit according to depths.

In addition, the image data decoder 230 may read information regarding a transformation unit according to a tree structure for each coding unit so as to perform inverse transformation based on transformation units for each coding unit, for inverse transformation for each LCU. Via the inverse transformation, a pixel value of the space domain of the coding unit may be reconstructed.

The image data decoder 230 may determine a depth of a current LCU by using splitting information according to depths. If the splitting information indicates that image data is no longer split in the current depth, the current depth is the depth. Accordingly, the image data decoder 230 may decode image data in the current LCU by using the information regarding the partition mode of the prediction unit, the information regarding the prediction mode, and the size information of the transformation unit for each coding unit corresponding to the depth.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information regarding the encoding mode for each coding unit.

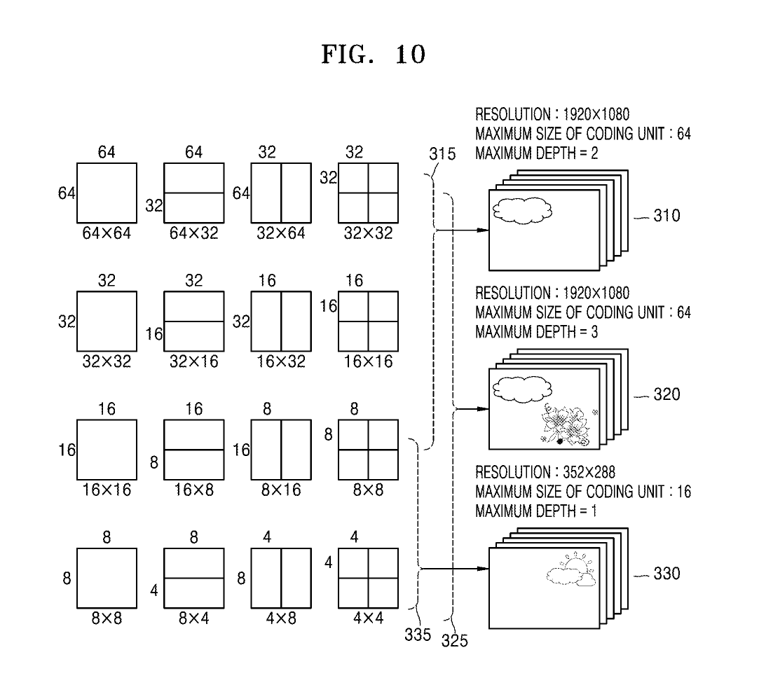

The video decoding device 10 described with reference to FIG. 10 may include the video decoding devices 200 of which the number is the same as that of views in order to reconstruct images in the first layer and the second layer by decoding a received first layer image stream and a received second layer image stream.

When receiving the first layer image stream, the image data decoder 230 of the video decoding device 200 may split samples of the images in the first layer that are extracted from the first layer image stream by the extractor 220 into coding units having the tree structure in a LCU. The image data decoder 230 may reconstruct the images in the first layer for each of the coding units having the tree structure by performing motion compensation on a prediction unit for predicting images

When receiving the second layer image stream, the image data decoder 230 of the video decoding device 200 may split samples of the images in the second layer that extracted from the first layer image stream by the image data and encoding information extractor 220 into coding units having the tree structure in a LCU. The image data decoder 230 may reconstruct the images in the second layer for each of the coding units having the tree structure by performing motion compensation on a prediction unit for predicting images

The image data and encoding information extractor 220 may obtain information regarding a brightness difference in order to compensate for a brightness difference between the images in the first layer and the images in the second layer. However, whether to compensate for the brightness differences may be determined according to an encoding mode of the coding unit. For example, brightness compensation may be performed only for a coding unit of 2N×2N.

As a result, the video decoding device 200 may obtain information regarding coding units having a least encoding error by recursively performing encoding on a largest coding unit (LCU) and may use the obtained information to decode the current picture. That is, encoded image data of the coding units having a tree structure may be decoded, and the coding units are determined as optimum coding units in each LCU.

Therefore, although an image has a high resolution or an excessively large data amount, by using optimum splitting information transmitted from the coding units, image data may be effectively decoded and reconstructed according to sizes of the coding units that are adaptively determined considering characteristics of the image, and encoding modes.

FIG. 10 illustrates a concept of a coding unit according to an exemplary embodiment.

A size of a coding unit may be expressed by width×height, and may be 64×64, 32×32, 16×16, and 8×8. A coding unit of 64×64 may be split into partitions of 64×64, 64×32, 32×64, or 32×32, a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a LCU to a SCU.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a LCU having a long axis size of 64, and coding units having long axis sizes of 32 and 16 since depths are deepened to two layers by splitting the LCU twice. Since the maximum depth of the video data 330 is 1, coding units 335 of the video data 330 may include a LCU having a long axis size of 16, and coding units having a long axis size of 8 since depths are deepened to one layer by splitting the LCU once.

Since the maximum depth of the video data 320 is 3, coding units 325 of the video data 320 may include a LCU having a long axis size of 64, and coding units having long axis sizes of 32, 16, and 8 since the depths are deepened to 3 layers by splitting the LCU three times. As a depth deepens, detailed information may be precisely expressed.

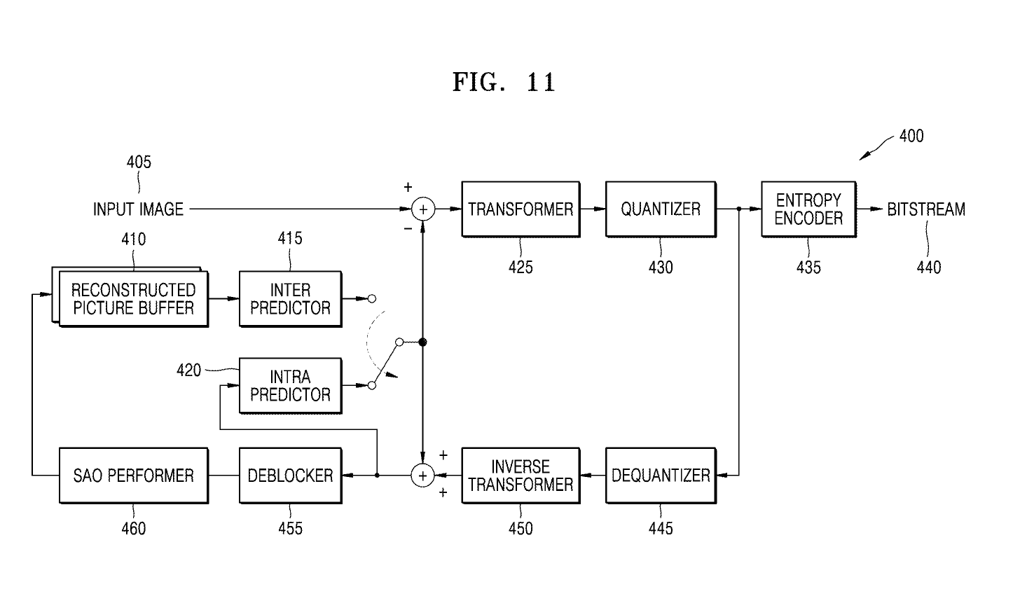

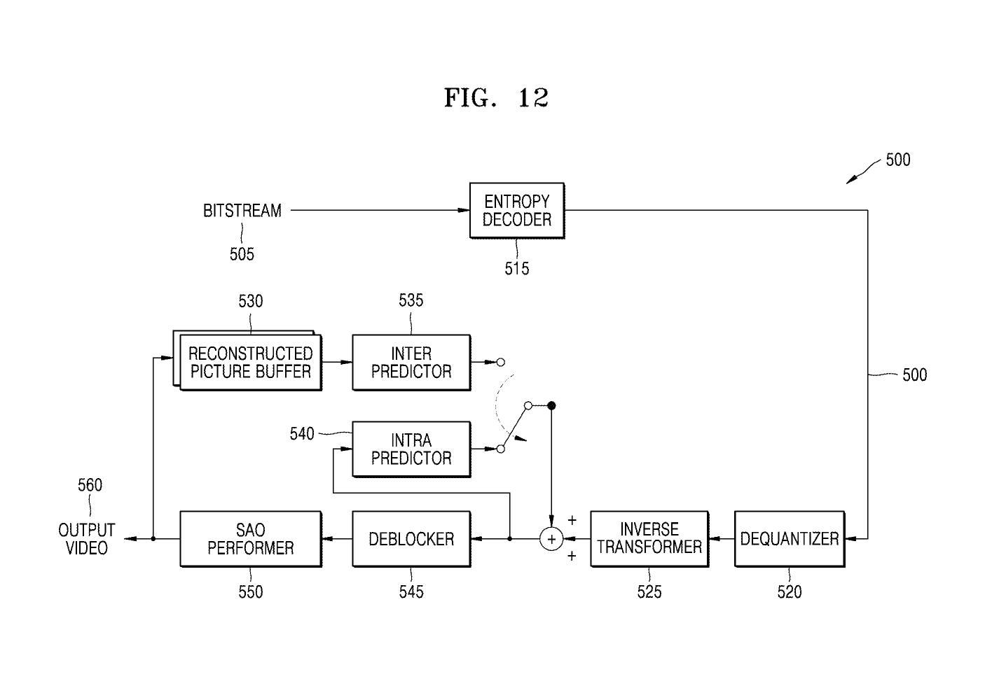

FIG. 11 illustrates a block diagram of an image encoder 400 based on a coding unit, according to an exemplary embodiment.

The image encoder 400 performs operations necessary for encoding image data in the picture encoder 120 of the video encoding device 100. In other words, an intra predictor 420 performs intra prediction on coding units in an intra mode according to prediction units, from among a current frame 405, and an inter predictor 415 performs inter prediction on coding units in an inter mode by using the current image 405 and a reference image obtained from a reconstructed picture buffer 410 according to prediction units. The current frame 405 may be split into LCUs and then the LCUs may be sequentially encoded. In this regard, the LCUs that are to be split into coding units having a tree structure may be encoded.

Residue data is generated by removing prediction data regarding coding units of each mode that is output from the intra predictor 420 or the inter predictor 415 from data regarding encoded coding units of the current frame 405, and is output as a quantized transformation coefficient according to transformation units through a transformer 425 and a quantizer 430. The quantized transformation coefficient is reconstructed as the residue data in a space domain through a dequantizer 445 and an inverse transformer 450. The reconstructed residue data in the space domain is added to prediction data for coding units of each mode that is output from the intra predictor 420 or the inter predictor 415 and thus is reconstructed as data in a space domain for coding units of the current image 405. The reconstructed data in the space domain is generated as reconstructed images through a de-blocker 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bit stream 440 through an entropy encoder 435.

In order for the image encoder 400 to be applied in the video encoding device 100, all elements of the image encoder 400, i.e., the inter predictor 415, the intra predictor 420, the transformer 425, the quantizer 430, the entropy encoder 435, the dequantizer 445, the inverse transformer 450, the de-blocker 455, and the SAO performer 460, perform operations based on each coding unit among coding units having a tree structure according to each LCU.

In particular, the intra predictor 420 and the inter predictor 415 determine a partition mode and a prediction mode of each coding unit from among the coding units having a tree structure in consideration of the maximum size and the maximum depth of a current LCU, and the transformer 425 may determine whether to split a transformation unit having a quad tree structure in each coding unit among the coding units having a tree structure.

FIG. 12 illustrates a block diagram of an image decoder 500 based on a coding unit, according to an exemplary embodiment.

An entropy decoder 515 parses encoded image data to be decoded and encoding information required for decoding from a bit stream 505. The encoded image data is a quantized transformation coefficient from which residue data is reconstructed by a dequantizer 520 and an inverse transformer 525.

An intra predictor 540 performs intra prediction on coding units in an intra mode according to each prediction unit. An inter predictor 535 performs inter prediction on coding units in an inter mode from among the current images for each prediction unit by using a reference image obtained from a reconstructed picture buffer 530.

Prediction data and residue data regarding coding units of each mode, which passed through the intra predictor 540 and the inter predictor 535, are summed, and thus data in a space domain regarding coding units of the current image 405 may be reconstructed, and the reconstructed data in the space domain may be output as a reconstructed image 560 through a de-blocker 545 and an SAO performer 550. Reconstructed images stored in the reconstructed picture buffer 530 may be output as reference images.

In order to decode the image data in the picture decoder 230 of the video decoding device 200, operations after the entropy decoder 515 of the image decoder 500 according to an embodiment may be performed.

In order for the image decoder 500 to be applied in the video decoding device 200 according to an exemplary embodiment, all elements of the image decoder 500, i.e., the entropy decoder 515, the dequantizer 520, the inverse transformer 525, the intra predictor 540, the inter predictor 535, the de-blocker 545, and the SAO performer 550 may perform operations based on coding units having a tree structure for each LCU.

In particular, the intra predictor 540 and the inter predictor 535 may determine a partition mode and a prediction mode for each of the coding units having a tree structure, and the inverse transformer 525 may determine whether to split a transformation unit having a quad tree structure for each of the coding units.

The encoding operation of FIG. 10 and the decoding operation of FIG. 11 are a video stream encoding operation and a video stream decoding operation in a single layer, respectively. Therefore, if the encoder 12 of FIG. 4 encodes video streams in two or more layers, the image encoder 400 may be included in each layer. Similarly, when a decoder 26 of FIG. 10 decodes video streams in two or more layers, the image decoder 500 may be included in each layer.

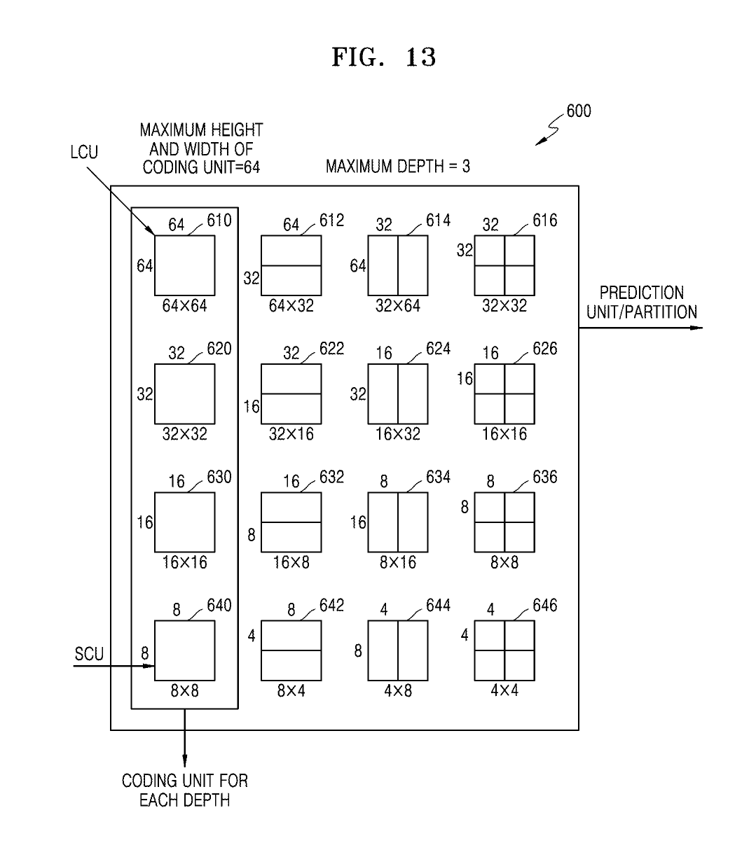

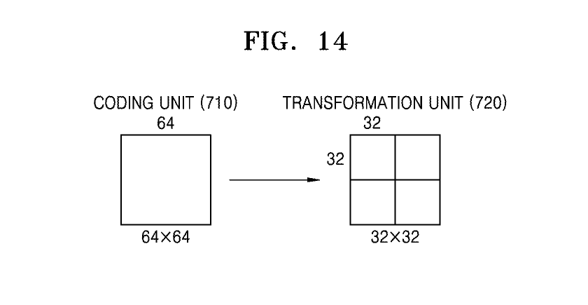

FIG. 13 illustrates coding units according to depths and partitions according to one or more exemplary embodiments.

The video encoding device 100 and the video decoding device 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to one or more exemplary embodiments, the maximum height and the maximum width of the coding units are each 64, and the maximum depth is 3. In this case, the maximum depth refers to a total number of times the coding unit is split from the LCU to the SCU. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a LCU in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3 exist. The coding unit 640 having a size of 8×8 and a depth of 3 is an SCU.

The prediction unit and the partitions of a coding unit are arranged along the horizontal axis according to each depth. In other words, if the coding unit 610 having a size of 64×64 and a depth of 0 is a prediction unit, the prediction unit may be split into partitions included in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition 630 having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine a depth of the LCU 610, the coding unit determiner 120 of the video encoding device 100 performs encoding for coding units corresponding to each depth included in the LCU 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the LCU 610 may be selected as the depth and a partition mode of the LCU 610.

FIG. 14 illustrates a relationship between a coding unit and a transformation unit according to an exemplary embodiment. The video encoding device 100 or the video decoding device 200 encodes or decodes images in coding units having the smaller or the same size as the LCU, in each LCU. A size of a transformation unit for transformation may be selected based on a data unit that is smaller than each coding unit.

For example, in the video encoding device 100 or the video decoding device 200, when a current coding unit 710 has a size of 64×64, the transformation may be performed by using a transformation unit 720 having a size of 32×32.

Also, after transformation is performed for data in the coding unit 710 having a size of 64×64 by using transformation units having sizes of 32×32, 16×16, 8×8, and 4×4, and the data is encoded, a transformation unit having a least error may be selected compared to an original data.

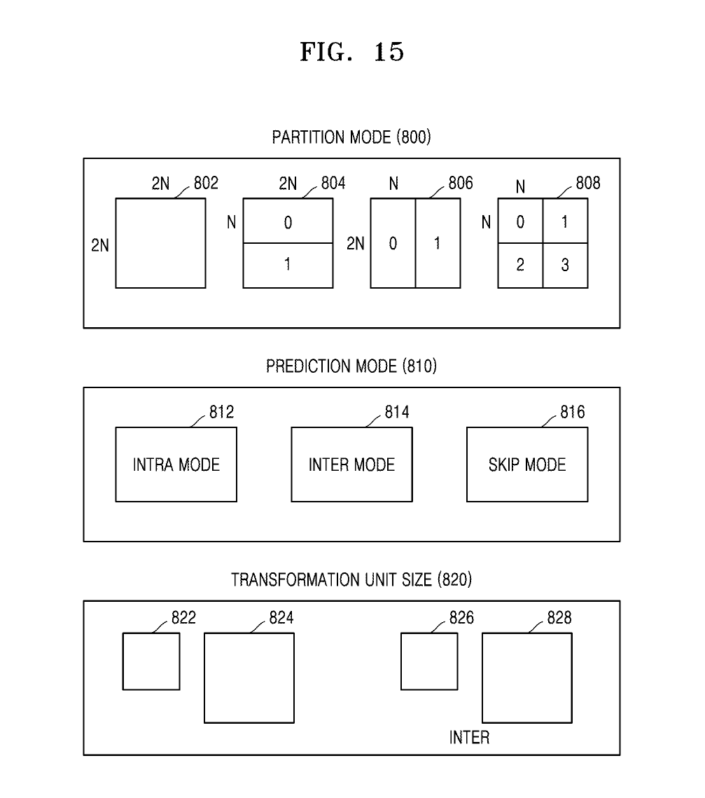

FIG. 15 illustrates encoding information according to depths according to an exemplary embodiment.

The output unit 130 of the video encoding device 100 may encode and transmit information 800 about a partition mode, information 810 about a prediction mode, and information 820 about a size of a transformation unit for each coding unit corresponding to a depth, as splitting information.

The information 800 indicates information about a type of a partition obtained by splitting a prediction unit of a current coding unit, wherein the partition is a data unit for prediction encoding of the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition mode is set to indicate one of the partition 802 having a size of 2N×2N, the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 810, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding device 200 may extract and use the information 800, 810, and 820 for decoding, according to each deeper coding unit.

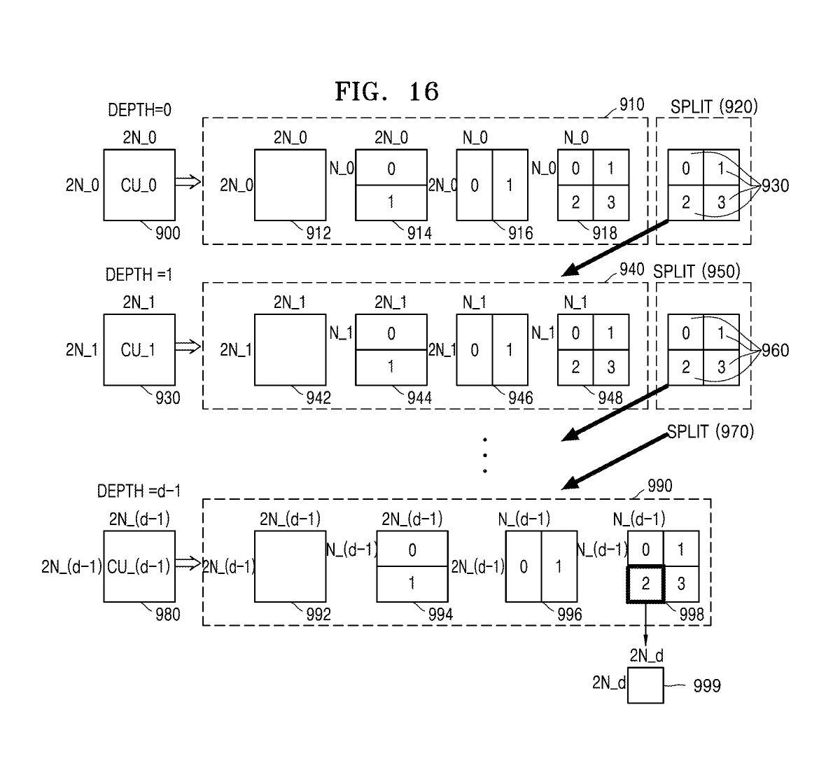

FIG. 16 illustrates deeper coding units according to depths according to one or more exemplary embodiments.

Splitting information may be used to indicate a change of a depth. The splitting information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition mode 912 having a size of 2N_{—}0×2N_{—}0, a partition mode 914 having a size of 2N_{—}0×N_{—}0, a partition mode 916 having a size of N_{—}0×2N_{—}0, and a partition mode 918 having a size of N_{—}0×N_{—}0. FIG. 16 only illustrates the partition modes 912 through 918 which are obtained by symmetrically splitting the prediction unit 910, but a partition mode is not limited thereto, and the partitions of the prediction unit 910 may include asymmetrical partitions, partitions having an arbitrary shape, partitions having a geometrical shape, or the like.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition mode. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition modes 912, 914, and 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition mode 942 having a size of 2N_{—}1×2N_{—}1, a partition mode 944 having a size of 2N_{—}1×N_{—}1, a partition mode 946 having a size of N_{—}1×2N_{—}1, and a partition mode 948 having a size of N_{—}1×N_{—}1.

If an encoding error is the smallest in the partition mode 948 having a size of N_{—}1×N_, a depth is changed from 1 to 2 to split the partition mode 948 in operation 950, and encoding is repeatedly performed on coding units 960, which have a depth of 2 and a size of N_{—}2×N_{—}2 to search for a minimum encoding error.

When a maximum depth is d, the deeper coding units according to the depths are set up to when a depth becomes d−1, and splitting information may be set up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), and four partitions having a size of N_(d−1)×N_(d−1) from among the partition modes 992 through 998 to search for a partition mode having a minimum encoding error.

Even when the partition mode 998 having a size of N_(d−1)×N_(d−1) has the minimum encoding error, since a maximum depth is d, a coding unit CU_(d−1) having a depth of d−1 is no longer split to a lower depth, and a depth for the coding units constituting a current LCU 900 is determined to be d−1 and a partition mode of the current LCU 900 may be determined to be N_(d−1)×N_(d−1). Also, since the maximum depth is d, splitting information for the coding unit 652 having a depth of d−1 is not set.

A data unit 999 may be a ‘minimum unit’ for the current LCU. A minimum unit according to one or more exemplary embodiments may be a square data unit obtained by splitting an SCU 980 by 4. By performing the encoding repeatedly, the video encoding device 100 may select a depth having the least encoding error by comparing encoding errors according to depths of the coding unit 900 so as to determine a depth, and set a corresponding partition mode and a prediction mode as an encoding mode of the depth.

As such, the minimum encoding errors according to depths are compared in all of the depths of 0 through d, and a depth having the least encoding error may be determined as a depth. The depth, the partition mode of the prediction unit, and the prediction mode may be encoded and transmitted as splitting information. Also, since a coding unit is split from a depth of 0 to a depth, only splitting information of the depth is set to 0, and splitting information of depths excluding the depth is set to 1.

The image data and encoding information extractor 220 of the video decoding device 200 may extract and use the information about the depth and the prediction unit of the coding unit 900 in order to decode the partition 912. The video decoding device 200 may determine a depth, in which splitting information is 0, as a depth by using splitting information according to depths, and use the splitting information about the corresponding depth for decoding.

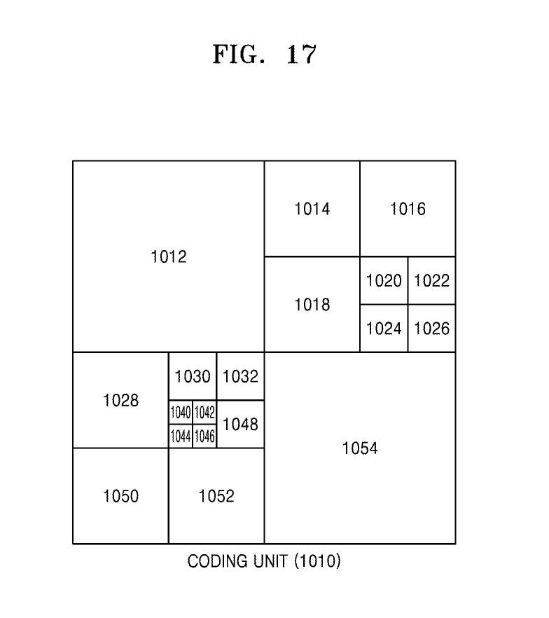

FIGS. 17 to 19 illustrate relationships a coding unit, a prediction unit, and a transformation unit according to one or more exemplary embodiments.

The coding units 1010 are coding units having a tree structure, corresponding to depths determined by the video encoding device 100, in a LCU. The prediction units 1060 are partitions of prediction units of each of the coding units 1010, and the transformation units 1070 are transformation units of each of the coding units 1010.

When a depth of a LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partitions 1014, 1022, 1050, and 1054 have a size of 2N×N, partitions 1016, 1048, and 1052 have a size of N×2N, and a partition 1032 has a size of N×N. Prediction units and partitions of the coding units 1010 are smaller than or equal to each coding unit.

Transformation or inverse transformation is performed on image data of the transformation unit 1052 among the transformation units 1070 in a data unit that is smaller than the coding unit. Also, the transformation units 1014, 1016, 1022, 1032, 1048, 1050, 1052, and 1054 are different the prediction modes and partitions in the prediction units 1060 in terms of sizes and shapes. In other words, the video encoding and decoding devices 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a LCU in order to determine an optimum coding unit, and thus coding units having a recursive tree structure may be obtained. Encoding information may include splitting information about a coding unit, information about a partition mode, information about a prediction mode, and information about a size of a transformation unit. Table 1 shows the encoding information that may be set by the video encoding and decoding devices 100 and 200.

TABLE 1

| Split information 0 | | | | | Split |
|---|---|---|---|---|---|
| (Encoding on Coding Unit having Size of 2N × 2N and Current Depth of d) | | | | | information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | information 0 of | information 1 of | having |
| Skip | mode | mode | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding device 100 may output the encoding information about the coding units having a tree structure, and the image data and encoding information extractor 220 of the video decoding device 200 may extract the encoding information about the coding units having a tree structure from a received bit stream.

Splitting information indicates whether a current coding unit is split into coding units of a lower depth. If splitting information of a current depth d is 0, a depth, in which a current coding unit is no longer split into a lower depth, is a depth, and thus information about a partition mode, prediction mode, and a size of a transformation unit may be defined for the depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure may be assigned to at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a LCU may be determined.

Accordingly, if a current coding unit is predicted based on adjacent data units, encoding information of data units in deeper coding units adjacent to the current coding unit may be directly referred to and used.

Alternatively, if a current coding unit is predicted based on adjacent data units, data adjacent to the current coding unit is searched using encoding information of the deeper coding units, and the searched adjacent coding units may be referred for predicting the current coding unit.

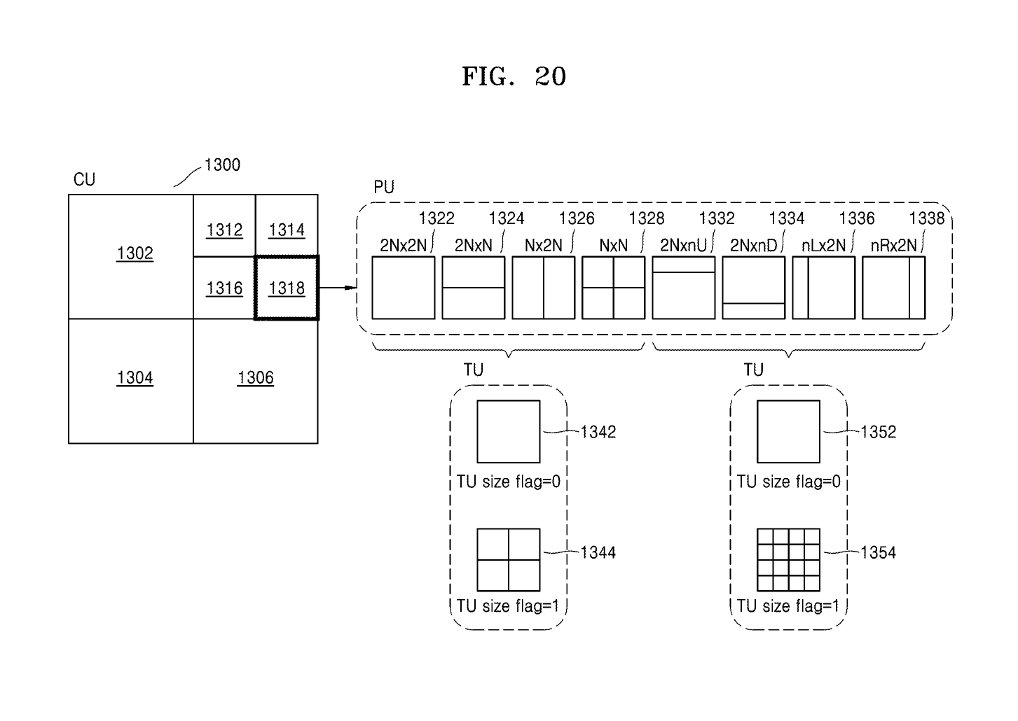

FIG. 20 illustrates a relationship between a coding unit, a prediction unit, and a transformation unit according to encoding mode information of Table 1.

A LCU 1300 includes coding units 1302, 1304, 1306, 1312, 1314, 1316, and 1318 of depths. Here, since the coding unit 1318 is a coding unit of a depth, splitting information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Splitting information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

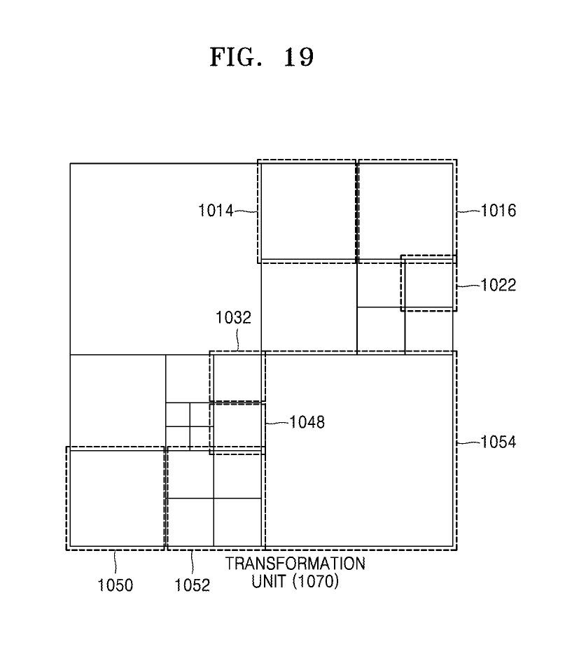

Referring to FIG. 19, the TU size flag is a flag having a value or 0 or 1, but the TU size flag is not limited to a 1-bit flag, and a transformation unit may be hierarchically split while the TU size flag increases from 0. Splitting information (TU size flag) of a transformation unit may be an example of a transformation index.

In this case, the size of a transformation unit that has been actually used may be expressed by using a TU size flag of a transformation unit, according to one or more exemplary embodiments, together with a maximum size and minimum size of the transformation unit. The video encoding device 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding device 200 may decode a video by using the maximum transformation unit size information, the minimum transformation unit size information, and the maximum TU size flag.

For example, (a) if the size of a current coding unit is 64×64 and a maximum transformation unit size is 32×32, (a−1) the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) the size of the transformation unit may be 32×32 when the TU size flag is 0. Here, the TU size flag cannot be set, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that may be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that may be determined in the current coding unit, a transformation unit size ‘RootTuSize’ when the TU size flag is 0 may denote a maximum transformation unit size that may be selected in the system. That is, in Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that may be determined in the current coding unit.

According to one or more exemplary embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example, and the exemplary embodiments are not limited thereto.

According to the video encoding method based on coding units having the tree structure as described with reference to FIGS. 8 through 20, image data of the space domain is encoded for each coding unit of a tree structure. According to the video decoding method based on coding units having a tree structure, decoding is performed for each LCU to reconstruct image data of the space domain. Thus, a picture and a video that is a picture sequence may be reconstructed. The reconstructed video may be reproduced by a reproducing device, stored in a storage medium, or transmitted through a network.

The exemplary embodiments of the inventive concept may be written as computer programs and may be implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), etc.

For convenience of description, the above-described method of encoding a video and/or video encoding method will be referred to as a ‘video encoding method’. Also, the above-described method of decoding a video and/or video decoding method will be referred to as a ‘video decoding method’.

Also, the video encoding device 40, the video encoding device 100, or the video encoding device including the image encoder 400 will be referred to as a ‘video encoding device according to one or more exemplary embodiments’. In addition, the video decoding device 10, the video decoding device 200, or the video decoding device including the image decoder 500 will be referred to as a ‘video decoding device according to one or more exemplary embodiments’.

A computer-readable recording medium storing a program, e.g., a disc 26000, according to one or more exemplary embodiments will now be described in detail.

FIG. 21 illustrates a physical structure of the disc 26000 in which a program is stored, according to an exemplary embodiment. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantization parameter determination method, the video encoding method, and the video decoding method described above may be assigned and stored.

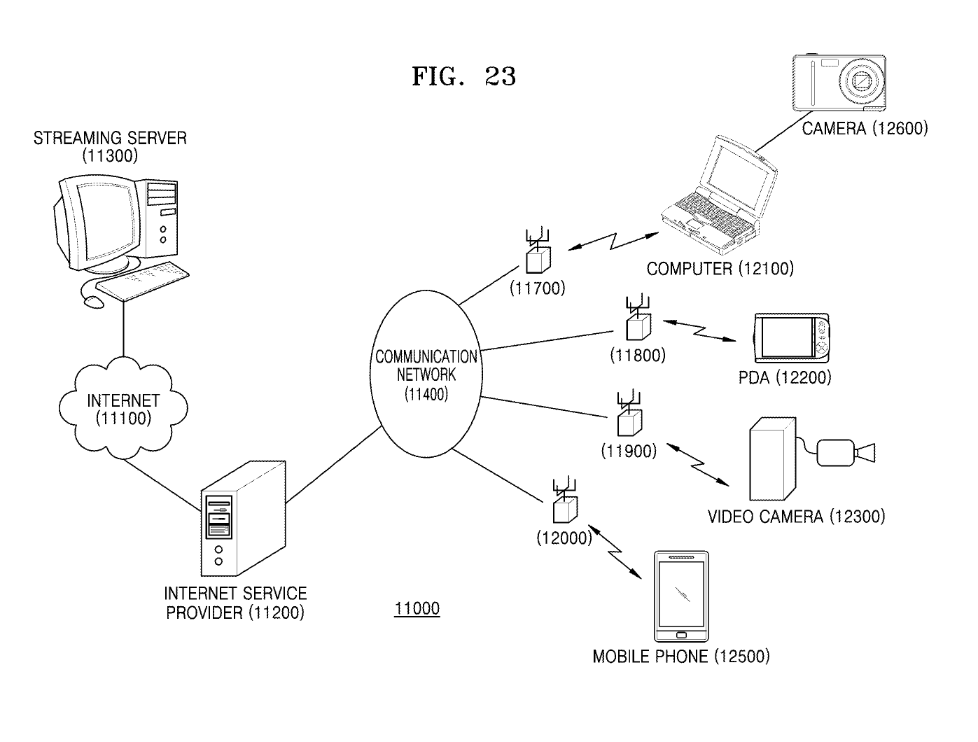

A computer system embodied using a storage medium that stores a program for executing the video encoding method and the video decoding method as described above will now be described with reference to FIG. 22.

FIG. 22 illustrates a disc drive 28000 for recoding and reading a program by using the disc 26000. A computer system 26700 may store a program that executes at least one of a video encoding method and a video decoding method according to one or more exemplary embodiments, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of a video encoding method and a video decoding method according to one or more exemplary embodiments may be stored not only in the disc 26000 illustrated in FIGS. 21 and 22 but also in a memory card, a ROM cassette, or a solid state drive (SSD).

A system to which the video encoding method and a video decoding method described above are applied will be described below.

FIG. 23 illustrates an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes independent devices. For example, the independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

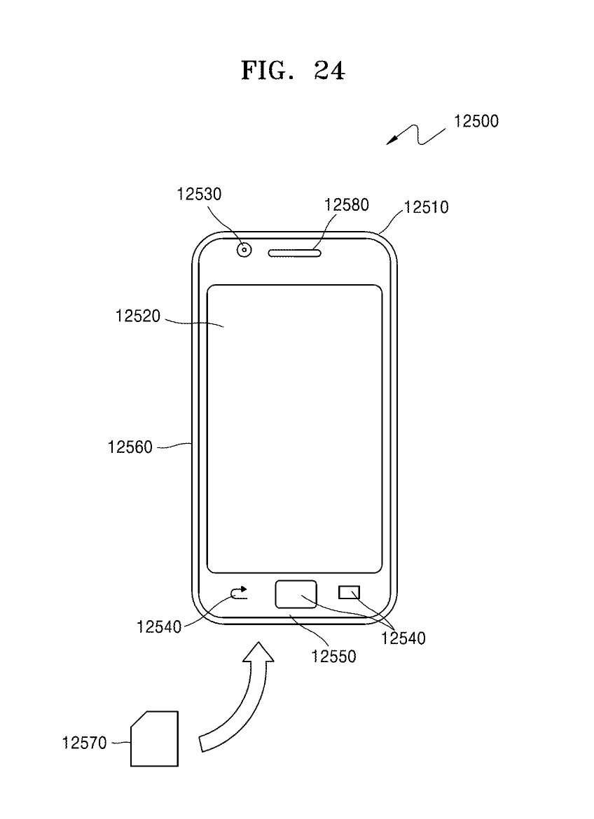

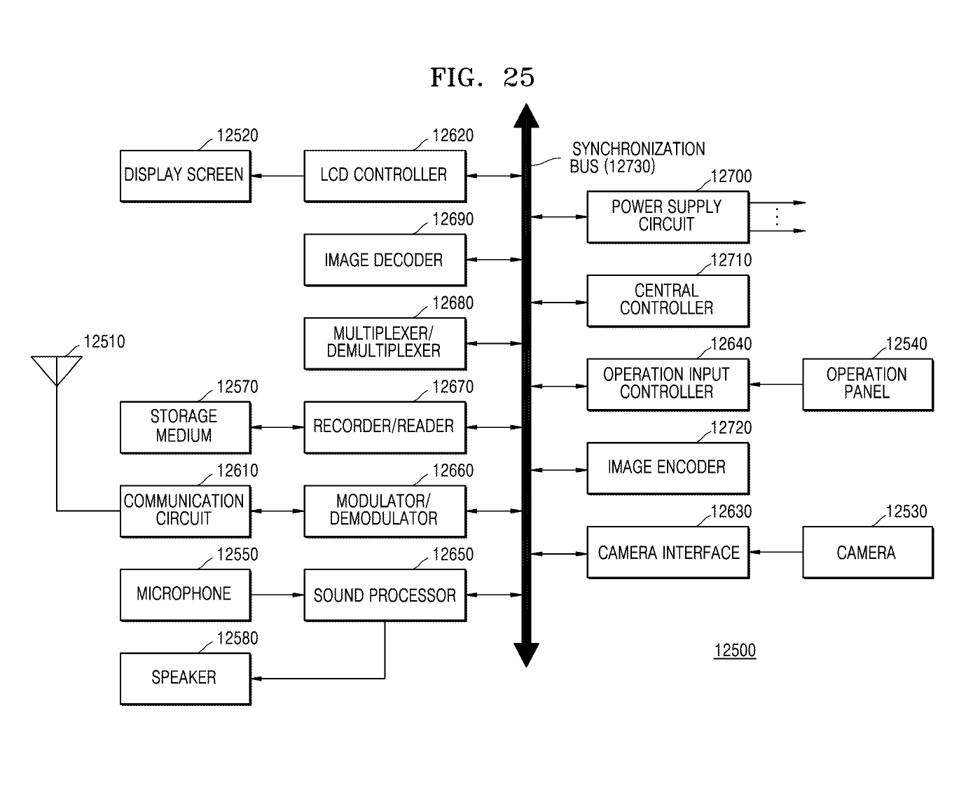

However, the content supply system 11000 is not limited to as illustrated in FIG. 24, and devices may be selectively connected thereto. The independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the independent devices included in the content supply system 11000 may be similar to those of a video encoding device and a video decoding device according to one or more exemplary embodiments.

The mobile phone 12500 included in the content supply system 11000 according to one or more exemplary embodiments will now be described in greater detail with referring to FIGS. 24 and 25.

FIG. 24 illustrates an external structure of the mobile phone 12500 to which a video encoding method and a video decoding method are applied, according to one or more exemplary embodiments. The mobile phone 12500 may be a smart phone, the functions of which are not limited and a large number of the functions of which may be changed or expanded by using application programs.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The smart phone 12510 includes a speaker 12580 for outputting voice and sound or another type of sound outputter, and a microphone 12550 for inputting voice and sound or another type sound inputter. The smart phone 12510 further includes the camera 12530, such as a charge-coupled device (CCD) camera, to capture a video and still images. The smart phone 12510 may further include a storage medium 12570 for storing encoded/decoded data, e.g., a video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), ROM, and RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described video encoding method according to the one or more exemplary embodiments. The image encoder 12720 may transform the image data received from the camera 12530 into compressed and encoded image data based on the above-described video encoding method according to the one or more exemplary embodiments, and then may output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the video decoder 12690, the sound processor 12650, or the LCD controller 12620, according to the type of the digital signal.

In the conversation mode, the mobile phone 12500 amplifies a signal received via the antenna 12510 and generates a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoder 12690 and the sound processor 12650, respectively.

A structure of the image decoder 12690 may correspond to that of the above-described video decoding device according to the one or more exemplary embodiments. The image decoder 12690 may decode the encoded video data to obtain reconstructed video data and provide the reconstructed video data to the display screen 12520 via the LCD controller 12620, by using the above-described video decoding method according to the one or more exemplary embodiments.

Thus, the video data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding device and a video decoding device according to one or more exemplary embodiments, may be a transceiving terminal including only the video encoding device, or may be a transceiving terminal including only the video decoding device.

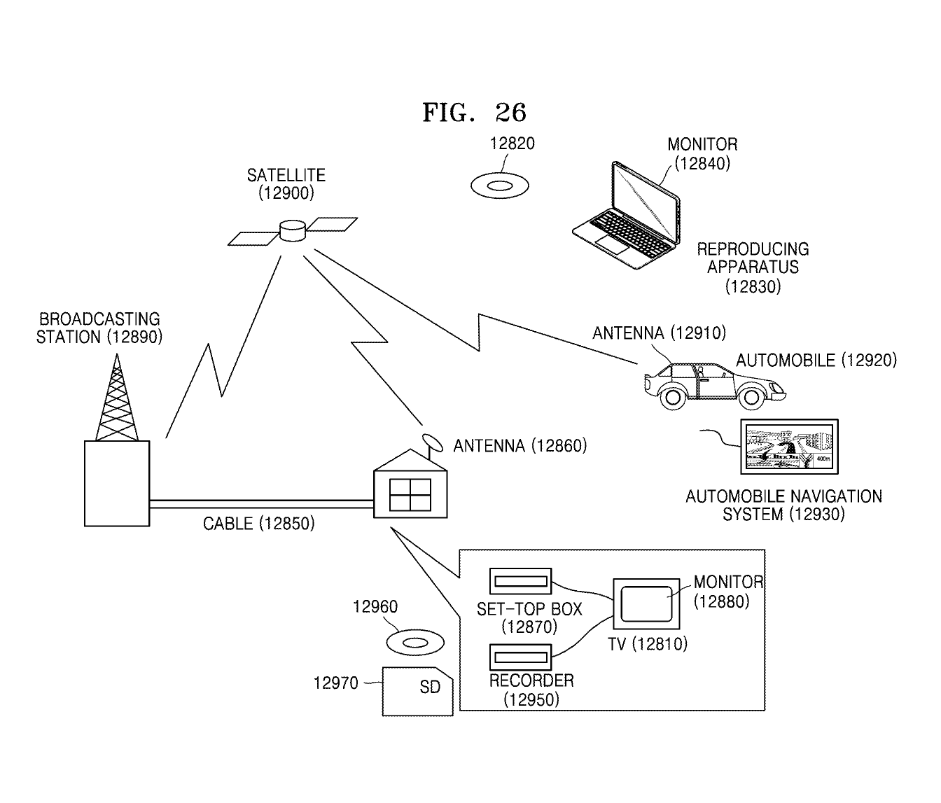

A communication system according to the one or more exemplary embodiments is not limited to the communication system described above with reference to FIG. 24. For example, FIG. 26 illustrates a digital broadcasting system employing a communication system, according to one or more exemplary embodiments. The digital broadcasting system of FIG. 26 may receive a digital broadcast transmitted via a satellite or a terrestrial network by using a video encoding device and a video decoding device according to one or more exemplary embodiments.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding device according to one or more exemplary embodiments is implemented in a reproducing device 12830, the reproducing device 12830 may parse and decode an encoded video stream recorded on a storage medium 12820, such as a disc or a memory card in order to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding device according to one or more exemplary embodiments may be installed. Data output from the set-top box 12870 may also be reproduced on a TV monitor 12880.

As another example, a video decoding device according to one or more exemplary embodiments may be installed in the TV receiver 12810 instead of the set-top box 12870.

An automobile 12920 that has an appropriate antenna 12910 may receive a signal transmitted from the satellite 12800 or the wireless base station 11700. A decoded video may be reproduced on a display screen of an automobile navigation system 12930 installed in the automobile 12920.

A video signal may be encoded by a video encoding device according to one or more exemplary embodiments and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding device according to one or more exemplary embodiments, a video signal recorded on the DVD disc 12960, the SD card 12970, or another storage medium may be reproduced on the monitor 12880.

The automobile navigation system 12930 may not include the camera 12530, the camera interface 12630 and the image encoder 12720 of FIG. 26. For example, the computer 12100 and the TV receiver 12810 may not include the camera 12530, the camera interface 12630, and the image encoder 12720 of FIG. 26.

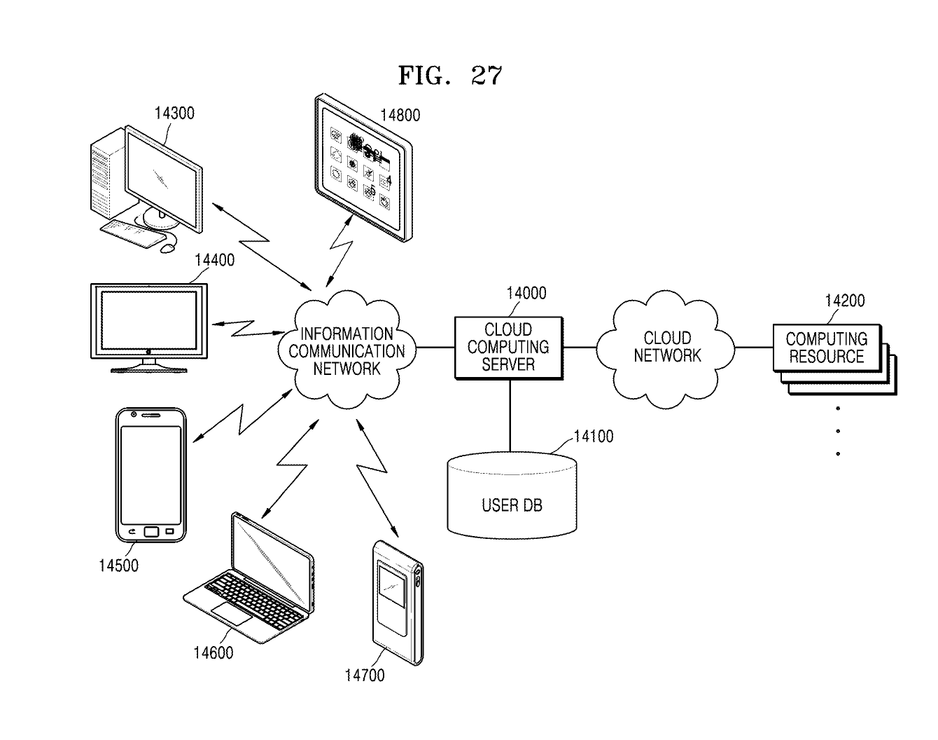

FIG. 27 illustrates a network structure of a cloud computing system using a video encoding device and a video decoding device, according to an exemplary embodiment.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding device as described above with reference to FIGS. 1A through 27. As another example, the user terminal may include a video encoding device as described above with reference to FIGS. 1A through 27. Alternatively, the user terminal may include both the video decoding device and the video encoding device as described above with reference to FIGS. 1A through 27.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

1. A method of decoding a video, the method comprising:
obtaining, from a received data stream, information indicating whether a current slice segment is a dependent slice segment;
obtaining constraint information from a reserved bit included in the received data stream when the current slice segment is not the dependent slice segment, based on the obtained information; and
determining whether the current image is used as a reference image for predicting another image, based on the obtained constraint information.

2. The method of claim 1, wherein the constraint information comprises flag information indicating whether the current image is used as the reference image.

3. The method of claim 2, wherein the flag information comprises bit information, wherein the bit information becomes 1 when the current image is not used as a reference image for inter prediction and becomes 0 when the current image is used as the reference image for inter prediction.

4. The method of claim 2, wherein the flag information comprises bit information, wherein the bit information becomes 1 when the current image is not used as a reference image for interlayer prediction and becomes 0 when the current image is used as the reference image for interlayer prediction.

5. The method of claim 1, wherein the determining of whether the current image is used as the reference image for predicting the other image comprises determining whether the current image is used as the reference image for predicting the other image when interlayer prediction between images included in different layers is performed.

6. The method of claim 1, wherein the determining of whether the current image is used as the reference image for predicting the other image comprises determining whether the current image is used as the reference image for predicting the other image when inter prediction between images included in a same layer is performed.

7. The method of claim 1, wherein the constraint information is obtained from at least one of a slice segment header, a video parameter set, a sequence parameter set, and a picture parameter set.

8. A method of encoding a video, the method comprising:
determining whether a current slice segment is a dependent slice segment;
determining whether a current image is used as a reference image for predicting another image when the current slice segment is the dependent slice segment;
determining a reserved bit including constraint information regarding whether the current image is used as the reference image for predicting the other image; and
generating a data stream including the determined reserved bit.

9. The method of claim 9, wherein the constraint information comprises flag information indicating whether the current image is used as the reference image.

10. The method of claim 10, wherein the flag information comprises bit information, wherein the bit information becomes 1 when the current image is not used as a reference image for inter prediction and becomes 0 when the current image is used as the reference image for inter prediction.

11. The method of claim 10, wherein the flag information comprises bit information, wherein the bit information becomes 1 when the current image is not used as a reference image for interlayer prediction and becomes 0 when the current image is used as the reference image for interlayer prediction.

12. The method of claim 9, wherein the determining of whether the current image is used as the reference image for predicting the other image comprises determining whether the current image is used as the reference image for predicting the other image when interlayer prediction between images included in different layers is performed.

13. A video decoding device comprising:
an obtainer configured to obtain, from a received data stream, information indicating whether a current slice segment is a dependent slice segment and obtain constraint information from a reserved bit included in the received data stream when the current slice segment is not the dependent slice segment, based on the obtained information; and
a decoder configured to determine whether a current image is used as a reference image for predicting another image based on the obtained constraint information.

14. A video encoding device comprising:
an encoder configured to determine whether a current slice segment is a dependent slice segment, determine whether a current image is used as a reference image for predicting another image when the current slice segment is not the dependent slice segment, and determine a reserved bit comprising constraint information regarding whether the current image is used as the reference image for predicting the other image; and
a data stream generator configured to generate a data stream comprising the determined reserved bit.

15. A non-transitory computer-readable having embodied thereon a computer program, which when executed by a computer, performs the method of claim 1.
